(19) United States
(12) Patent Application Publication
(10) Pub. No.: US 2022/0234078 A1
(43) Pub. Date: Jul. 28, 2022

(54) Automated Feeding, Sorting, and Packaging System for a Farm with Robots Working on Plants

(71) Applicant: Michael Anthony Bartrom, MARION, IN (US)

(72) Inventor: Michael Anthony Bartrom, MARION, IN (US)

(21) Appl. No.: 17/717,523

(22) Filed: Apr. 11, 2022

Related U.S. Application Data
(63) Continuation-in-part of application No. 17/210,701, filed on Mar. 24, 2021.
Application No. 17/210,701 is a continuation of application No. PCT/US2020/013342, filed on Jan. 13, 2020.
(60) Provisional application No. 63/258,088, filed on Apr. 12, 2021.
(60) Provisional application No. 63/360,349, filed on Sep. 24, 2021.
(60) Provisional application No. 62/917,017, filed on Nov. 14, 2018.

(51) Int. Cl. B07C 5/342; B07C 5/36; B65G 43/08; B25J 15/12; B07C 5/28; A01G 9/14

(52) U.S. Cl. CPC B07C 5/3422; B07C 5/362; B65G 43/08; A01D 45/065; B07C 5/28; A01G 9/143; B25J 15/12

(57) ABSTRACT

An automated feeding, sorting, and packaging system includes a first conveyor belt and a second conveyor belt adjacent to the first conveyor belt. The second conveyor belt moves slightly faster than the first conveyor belt. A rotating size separation tool has slits or pockets, and is located between the first and second conveyor belt. The automated feeding, sorting, and packaging system also includes a backlit conveyor belt. A vision guided robot is arranged adjacent to the backlit conveyor belt. The vision guided robot is provided with a robotic gripper and a vision sensor. At least one scales is arranged adjacent to the vision guided robot. An arrangement of temporary storage bins is arranged adjacent to the vision guided robot. The automated feeding, sorting, and packaging system also includes a container handling system. A computer-based control system is connected to the vision guided robot and to the at least one scales.

### CROSS-REFERENCE TO RELATED APPLICATIONS

The present application claims priority to Provisional Patent Application No. 63/258,088 filed Apr. 12, 2021, claims priority to Provisional Patent Application No. 63/360,349 filed Sep. 24, 2021, and is a Continuation In Part of U.S. application Ser. No. 17/210,701 filed Mar. 24, 2021, which is a Continuation of International Application PCT/US2020/013342 filed Jan. 13, 2020, which claims benefit under 35 U.S.C. § 119(e) of U.S. Provisional No. 62/917,017, filed Nov. 14, 2018, the disclosures of which are expressly incorporated by reference herein in their entirety.

### BACKGROUND

### Field of Invention

Embodiments described herein generally relate to an Automated Farm with Robots Working on Plants, and specifically to an Automated Feeding, Sorting, and Packaging System for a Farm with Robots Working on Plants. The Automated Farm with Robots Working on Plants and the Automated Feeding, Sorting, and Packaging System for a Farm with Robots Working on Plants heavily automates indoor farming, especially the tasks of cloning, feeding, inspecting, maintaining, trimming or pruning, harvesting, sorting, and packaging cannabis and hemp plants. This is accomplished using robots with specialized attachments, conveyors, and dedicated rooms that are specifically arranged and controlled to facilitate various automated tasks and/or stages of development of the plants. The Automated Feeding, Sorting, and Packaging System may be applied to farms and other facilities that are not otherwise fully automated.

### Related Art

As a result of years of research and development, consumers have become increasingly knowledgeable about the side effects of medications and food manufacturing processes. Consumers are therefore demanding medications, food, and other consumables that are more healthy and natural. Specifically regarding medications, currently cannabis and hemp is becoming more and more popular, which is resulting in growth and expansion of the cannabis and hemp industry. CBD oil may be used to treat or cure various ailments without the harsh side effects resulting from many other treatments. Cannabis and hemp farms all over the world are incorporating new technology and innovations to advance the production process to new levels. However, there is still a large opportunity for improvements to be made.

One of the major challenges cannabis and hemp farmers face is how delicate and unusual the cannabis or hemp plant is. Cannabis and hemp plants differ from most other plants in that they are harder to clone, trim, harvest, and maintain. To get the most out of cannabis and hemp plants, they have to be tended daily. In this respect cannabis and hemp plants are not like a field crop. They are more similar to a garden crop but even more demanding in that they must be tended frequently. Since these plants have such high upkeep, cannabis and hemp production is manual, redundant, and tedious work. At the same time, the hemp industry is rapidly growing, so that hemp farms are struggling to keep up with demand and paying excessive labor costs in order to maintain their crop.

Another challenge that many growers and processors face is the process of separating, sorting, and packaging different sized flowers and/or buds in a batch of dried cannabis or hemp product. Touching or handling the product excessively during the process of separating, sorting, and packaging causes a greater amount of trichomes to fall off from the flowers and/or buds, resulting in lower quality product. Additionally, smaller flowers and/or buds tend to fall towards the bottom of the product as it is being processed. These smaller flowers and/or buds contain a large amount of the desirable trichomes. This is similar, for example, to a bag of potato chips. The broken chips along with all the salt, cheese, or other seasoning tend to accumulate at the bottom of the bag. Processing cannabis flowers and/or buds similarly tends to cause the trichomes to fall off and collect around the small flowers and/or buds at the bottom of the product. The more and rougher the flowers and/or buds are handled, the more this occurs.

80% of all cannabis or hemp flowers and/or buds sold in the United States is sold in ⅛^{th} ounce packages. There is also a demand to separate flowers and/or buds into different grades or sizes, as the grades or sizes of flowers and/or buds have different values. Moreover, consumers prefer a consistent mix of flower and/or bud sizes, rather than a container full of small flowers and/or buds. Therefore, growers and processors provide “value” to their customers and build their brands by delivering a consistent mix of flower and/or bud sizes. Yet, existing packaging solutions do not have the capability to sort and package cannabis based on the size of dried flowers and/or buds. This due at least in part to the fact that cannabis flowers and/or buds have inconsistent shapes, sizes, surface stickiness, densities, and etcetera. Such varying conditions are challenging to the maintenance of the integrity of flowers and/or buds during packaging operations, as well as to delivering a consistent mix of flower and/or bud sizes.

Accordingly, there is an unmet need for an Automated Farm with Robots Working on Plants that is capable of meeting production demands, while meeting the specific requirements of cannabis or hemp plant husbandry. Furthermore, there is an unmet need for a process and apparatus for gently separating and sizing cannabis buds and flowers, while providing a consistent mix of bud sizes with intact trichomes.

### SUMMARY

Embodiments described herein relate to an Automated Farm with Robots Working on Plants, and specifically to an Automated Feeding, Sorting, and Packaging System for a Farm with Robots Working on Plants, which may also be applied to farms and other facilities that are not otherwise fully automated. The Automated Farm with Robots Working on Plants comprises an automated indoor farm that includes specialized plant tending robots able to perform many of the cloning, trimming or pruning, harvesting, inspecting, maintaining, curing, and shipping tasks. Many of these tasks are accomplished using specialized tools attached to robots manufactured by FANUC America Corporation™, located at 3900 West Hamlin Rd., Rochester Hills, Mich. 48309. Additional engineered mechanisms contribute to the overall process. The specialized tools allow the robots to search the plants and find what they need in order to harvest, clone, trim, inspect, and maintain the plants. Conveyors and other devices are used to allow the entire farm to fully function under the supervision of a few people, rather than 30 or 40 employees normally required to operate a similarly sized farm.

The Automated Farm with Robots Working on Plants provides growing rooms for cannabis and hemp plants that are environmentally controlled, and specifically temperature, humidity, light, and air quality controlled for the needs of the plants at their various stages of cloning and development. Air exhausted from the growing rooms is filtered and treated in order to minimize any impact on the community in which the farm is located. The Automated Farm with Robots Working on Plants is physically arranged so that the cloning, inspecting, maintaining, trimming or pruning, and harvesting activities may be accomplished with minimal manual intervention. Each such activity is appointed a room and an arrangement of robots and other equipment that is efficiently dedicated to that task.

The cannabis and hemp plants at various stages of development are moved as necessary between and within rooms using power roller conveyors, chain transfers, lift mechanisms, gravity skate wheel conveyors, transports, motorized racks, and specialized pots and trays. The specialized pots and trays may be provided with trellises and/or training arms in order support the top-heavy cannabis or hemp plants, along with rotation holders that allow compatible rotating devices to rotate the cannabis or hemp plants in the tray. Robots using specialized tools receive the cannabis or hemp plants in their specialized trays and pots from the transport mechanisms, and are used to clone, trim or prune, harvest, inspect, and/or maintain the cannabis or hemp plants. Scrap material collection systems collect and dispose of scrap material. Other specialized robots and equipment perform transplanting and shipping tasks.

Small cubes of soil or Rockwool are used as a growing medium. They are handled and prepared by robots and other equipment, so that the robots having specialized tools for cloning, trimming, harvesting, and etcetera, are able to insert the clone plants into the prepared cubes of soil or Rockwool. Even the nursery that receives the newly cloned plants is heavily automated, with similar temperature, humidity, light, and air quality controls, and similar automated transport mechanisms, as the grow rooms.

A farm control and data management system based on a control system network is used to coordinate the functions of the Automated Farm with Robots Working on Plants. Generally, the control system network operates all aspects of the farm automation including cloning, trimming or pruning, harvesting, inspecting, and maintaining the plants. The control system network is connected to cloning cells, planting cells, pruning or trimming cells, harvesting cells, and etcetera, by way of Industrial Programmable Logic Controllers, which it uses to control the robots, transport mechanisms, and environmental controls. The control system network may also log a large amount of data including atmospheric conditions and pictures of the plants.

The Automated Feeding System for a Farm with Robots Working on Plants, then, includes multiple conveyors, one or more orbital rakes, one or more size separation tools, static diverters, and a pickup conveyor that allows a vision-guided robot to pick up cannabis or hemp flowers and/or buds. The size separation tool, in particular, allows larger flowers and/or buds to continue forward, while smaller sized flowers and/or buds and/or kief drop into a separated product catch pan, or on to a different conveyor that takes the smaller sized flowers and/or buds and/or kief to another process. (“Kief . . . refers to the pure and clean collection of loose cannabis trichomes, which are accumulated by being sifted from cannabis flowers or buds with a mesh screen or sieve.”)¹ The size separation tool may rotate in the same direction as the conveyor belts, although it is contemplated that the size separation tool may rotate in the opposite direction from the conveyor belts. Furthermore, the size separation tool may be controlled in such a way that it alternates between rotating in same direction as the conveyor belts and in the opposite direction from the conveyor belts. In such an embodiment, the ratio of rotations in same direction as the conveyor belts and in the opposite direction from the conveyor belts may be variable, according to the characteristics of the flowers and/or buds. ¹ Kief. 2 Apr. 2022. Retrieved 5 Apr. 2022. https://en.wikipedia.org/wiki/Kief#:˜:text=Kief%20(from%20Moroccan%20Arabic%20%D9%83%D9%8A%D9%81,a %20mesh%20screen%20or%20sieve.

The Automated Sorting and Packaging System for a Farm with Robots Working on Plants, meanwhile includes a pickup area, a vision guided robot, one or more scales, temporary storage bins, a container handling system, and a computer-based control system. The computer-based control system of the Automated Sorting and Packaging System allows the system to package cannabis or hemp flowers and/or buds, which may for non-limiting example be dried and/or trimmed, while collecting data using the scales and controlling the vision guided robot in order to achieve a consistent mix of sizes of flowers and/or buds in each container. As noted previously, 80% of all cannabis or hemp flowers and/or buds sold in the United States is sold in ⅛^{th} ounce packages. The computer-based control system of the Automated Sorting and Packaging System allows the system to package cannabis or hemp flowers and/or buds adjusting to any size package.

The computer-based control system uses one or more algorithms that utilize the size and weight data provided by the scales and by a vision sensor, which may be attached to the vision guided robot, or may be otherwise located above the pickup conveyor, in order to select and combine flowers and/or buds into “ideal” packages. For example, a user defines an ideal package size, weight, number of flowers and/or buds, and acceptable size range for flowers and/or buds. The computer-based control system then measures the size and weight range of a given number of flowers and/or buds within its tolerance capability. Next, the computer-based control system causes the Automated Sorting and Packaging System to store the flowers and/or buds that fit within the defined acceptable size range, while flowers and/or buds outside of that defined acceptable size range are separated. The computer-based control system then classifies all of the stored flowers and/or buds into the defined ranges, noting that some flowers and/or buds may fall into multiple ranges.

The computer-based control system then checks all possible combinations for the given number of flowers and/or buds, while retaining each combination in its memory having at least one flower and/or bud from each range. The combination closest to the target weight, but not less than the target weight, and within tolerance, is then processed. That is to say, the flowers and/or buds that make up that combination are removed from their storage location, and combined to create a completed package. The storage locations are then used in determining the next combination. The computer-based control system of the Automated Sorting and Packaging System controls all of the mechanical and electronic components that allow for sorting, weighing, storing, and combining flowers and/or buds for packaging. The computer-based control system may utilize Artificial Intelligence (AI) or machine learning in order to more efficiently select and combine flowers and/or buds into the “ideal” packages. Moreover, the computer-based control system can suggest ideal package configurations based on the history of product data previously processed.

In another aspect of the Automated Feeding, Sorting, and Packaging System for a Farm with Robots Working on Plants, the vision guided robot is provided with gripper fingers configured with a gripper finger truss that transfers gripping force from the mechanism of the gripper to interchangeable grip surfaces. The gripper fingers truss may be fashioned from a soft and pliable material, such as for non-limiting example thermoplastic polyurethane, and may be manufactured using a 30 printer. Further, select portions of the gripper finger truss, such as the inner chords, the outer chords, the webs, and/or the nodal joints therebetween, or any combination thereof, may be fashioned from a soft and pliable material, while the remainder thereof may be fashioned from stiffer material. Still further, select portions of the gripper finger truss may be fashioned using variable durometer material, so that the gripper finger truss elements vary in hardness and pliability along their length. In this way, the gripping force transmitted from the mechanism of the gripper to the interchangeable grip surfaces may be finely tuned to the needs of handling cannabis or hemp flowers and/or buds. It is noted that the interchangeable grip surfaces may be wider than the gripper finger truss, in order to facilitate picking up more than one flower and/or bud, and to further reduce the gripping pressure.

According to one embodiment of the invention, an automated farm has an automated feeding, sorting, and packaging system. The automated feeding, sorting, and packaging system includes a first conveyor belt and a second conveyor belt adjacent to the first conveyor belt. The second conveyor belt is configured to move slightly faster than the first conveyor belt. A rotating size separation tool has slits or pockets, and is located between the first and second conveyor belt. The automated feeding, sorting, and packaging system also includes a pickup conveyor belt and a vision sensor. A vision guided robot is arranged adjacent to the pickup conveyor belt. The vision guided robot is provided with a robotic gripper. At least one scales is arranged adjacent to the vision guided robot. An arrangement of temporary storage bins is arranged adjacent to the vision guided robot. The automated feeding, sorting, and packaging system also includes a container handling system. A computer-based control system is connected to the vision guided robot and to the at least one scales.

According to another embodiment of the invention, an automated feeding, sorting, and packaging system includes a first conveyor belt and a second conveyor belt adjacent to the first conveyor belt. The second conveyor belt is configured to move slightly faster than the first conveyor belt. A rotating size separation tool has slits or pockets, and is located between the first and second conveyor belt. The automated feeding, sorting, and packaging system also includes a pickup conveyor belt and a vision sensor. A vision guided robot is arranged adjacent to the pickup conveyor belt. The vision guided robot is provided with a robotic gripper. At least one scales is arranged adjacent to the vision guided robot. An arrangement of temporary storage bins is arranged adjacent to the vision guided robot. The automated feeding, sorting, and packaging system also includes a container handling system. A computer-based control system is connected to the vision guided robot and to the at least one scales.

According to another embodiment of the invention, a method for automated farming includes several steps. The first step is providing a first conveyor belt. The second step is configuring a second conveyor belt adjacent to the first conveyor belt to move slightly faster than the first conveyor belt. The third step is arranging a rotating size separation tool having slits or pockets, between the first and second conveyor belt. The fourth step is providing a pickup conveyor belt and a vision sensor. The fifth step is arranging a vision guided robot adjacent to the pickup conveyor belt. The sixth step is providing the vision guided robot with a robotic gripper. The seventh step is providing at least one scales adjacent to the vision guided robot. The eighth step is providing an arrangement of temporary storage bins adjacent to the vision guided robot. The ninth step is providing a container handling system. The tenth step is connecting a computer-based control system to the vision guided robot and to the at least one scales.

The Automated Feeding, Sorting, and Packaging System for a Farm with Robots Working on Plants is able to improve plant productivity, minimize labor, and better meet the specific requirements of cannabis and hemp plant husbandry. The principles of the Automated Feeding, Sorting, and Packaging System may be applied to farms and facilities that are not otherwise fully automated.

### DESCRIPTION OF THE DRAWINGS

The above-mentioned and other features of embodiments of the Automated Feeding, Sorting, and Packaging System for a Farm with Robots Working on Plants, and the manner of their working, will become more apparent and will be better understood by reference to the following description of embodiments of the Automated Feeding, Sorting, and Packaging System for a Farm with Robots Working on Plants taken in conjunction with the accompanying drawings, wherein:

FIG. 1 is a sectional end view of an embodiment of an Automated Farm with Robots Working on Plants, as described herein;

FIG. 2 is a floor plan of an embodiment of an Automated Farm with Robots Working on Plants, as described herein;

FIG. 3 is a plan view of a parent conveyor of an embodiment of an Automated Farm with Robots Working on Plants, as described herein;

FIG. 4A is an isometric view of a child conveyor of an embodiment of an Automated Farm with Robots Working on Plants, as described herein;

FIG. 4B is an isometric view of a storage rack of an embodiment of an Automated Farm with Robots Working on Plants, as described herein;

FIG. 4C is an end view of a storage and retrieval system of an embodiment of an Automated Farm with Robots Working on Plants, as described herein;

FIG. 5A is floor plan of a conveyor room of an embodiment of an Automated Farm with Robots Working on Plants, as described herein;

FIG. 5B is an end view of a two groove roller of an embodiment of an Automated Farm with Robots Working on Plants, as described herein;

FIG. 5C is a side view of a two groove roller of an embodiment of an Automated Farm with Robots Working on Plants, as described herein;

FIG. 5D is an isometric view of a conveyor of an embodiment of an Automated Farm with Robots Working on Plants, as described herein;

FIG. 6A is a top view of a tray and trellis of an embodiment of an Automated Farm with Robots Working on Plants, as described herein;

FIG. 6B is a side view of a tray and trellis of an embodiment of an Automated Farm with Robots Working on Plants, as described herein;

FIG. 6C is an isometric view of a tray and trellis of an embodiment of an Automated Farm with Robots Working on Plants, as described herein;

FIG. 6D is a section view of a tray of an embodiment of an Automated Farm with Robots Working on Plants, as described herein;

FIG. 7A is a top view of two robots of an embodiment of an Automated Farm with Robots Working on Plants, as described herein;

FIG. 7B is a side view of two robots of an embodiment of an Automated Farm with Robots Working on Plants, as described herein;

FIG. 7C is an isometric view of two robots of an embodiment of an Automated Farm with Robots Working on Plants, as described herein;

FIG. 7D is a detail view of two robots of an embodiment of an Automated Farm with Robots Working on Plants, as described herein;

FIG. 7E is a detail view of scrap removal by two robots of an embodiment of an Automated Farm with Robots Working on Plants, as described herein;

FIG. 8A is a top view of a pot and training tools assembly of an embodiment of an Automated Farm with Robots Working on Plants, as described herein;

FIG. 8B is a side view of a pot and training tools assembly of an embodiment of an Automated Farm with Robots Working on Plants, as described herein;

FIG. 8C is an isometric view of a pot and training tools assembly of an embodiment of an Automated Farm with Robots Working on Plants, as described herein;

FIGS. 8D and 8E are detail views of training tool assemblies of embodiments of an Automated Farm with Robots Working on Plants, as described herein;

FIG. 9A is a top view of a cloning and parent plant room of an embodiment of an Automated Farm with Robots Working on Plants, as described herein;

FIG. 9B is a side view of a clone preparation tank of an embodiment of an Automated Farm with Robots Working on Plants, as described herein;

FIG. 10A is a side view of a portable spray station of an embodiment of an Automated Farm with Robots Working on Plants, as described herein;

FIG. 10B is an end view of a portable spray station of an embodiment of an Automated Farm with Robots Working on Plants, as described herein;

FIG. 10C is a bottom view of a portable spray station of an embodiment of an Automated Farm with Robots Working on Plants, as described herein;

FIG. 11 is a plan view of an automated harvesting cell of an embodiment of an Automated Farm with Robots Working on Plants, as described herein;

FIG. 12 is an isometric view of a curing cabinet system of an embodiment of an Automated Farm with Robots Working on Plants, as described herein;

FIG. 13 is a graphic representation of a farm control and data management system of an Automated Farm with Robots Working on Plants, as described herein;

FIG. 14A is a top view of two robots of an embodiment of an Automated Farm with Robots Working on Plants, as described herein;

FIG. 14B is a side view of two robots of an embodiment of an Automated Farm with Robots Working on Plants, as described herein;

FIG. 14C is an isometric view of two robots of an embodiment of an Automated Farm with Robots Working on Plants, as described herein;

FIG. 15A is a top view of a backlight assembly of a robot of an embodiment of an Automated Farm with Robots Working on Plants, as described herein;

FIG. 15B is a front view of a backlight assembly of a robot of an embodiment of an Automated Farm with Robots Working on Plants, as described herein;

FIG. 15C is a sectional end view of a backlight assembly of a robot of an embodiment of an Automated Farm with Robots Working on Plants, as described herein;

FIG. 15D is a detail view of a backlight assembly of a robot of an embodiment of an Automated Farm with Robots Working on Plants, as described herein;

FIG. 15E is an isometric view of a backlight assembly of a robot of an embodiment of an Automated Farm with Robots Working on Plants, as described herein;

FIG. 16A is a top view of a robot having a light assembly of an embodiment of an Automated Farm with Robots Working on Plants, as described herein;

FIG. 16B is a side view of a robot having a light assembly of an embodiment of an Automated Farm with Robots Working on Plants, as described herein;

FIG. 16C is an isometric view of a robot having a light assembly of an embodiment of an Automated Farm with Robots Working on Plants, as described herein;

FIG. 17A is a top view of a grip-cut of a robot of an embodiment of an Automated Farm with Robots Working on Plants, as described herein;

FIG. 17B is a side view of a grip-cut of a robot of an embodiment of an Automated Farm with Robots Working on Plants, as described herein;

FIG. 17C is an end view of a grip-cut of a robot of an embodiment of an Automated Farm with Robots Working on Plants, as described herein;

FIG. 17D is an isometric view of a grip-cut of a robot of an embodiment of an Automated Farm with Robots Working on Plants, as described herein;

FIG. 18A is a top view of a robot having a grip-cut of an embodiment of an Automated Farm with Robots Working on Plants, as described herein;

FIG. 18B is a side view of a robot having a grip-cut of an embodiment of an Automated Farm with Robots Working on Plants, as described herein;

FIG. 18C is an isometric view of a robot having a grip-cut of an embodiment of an Automated Farm with Robots Working on Plants, as described herein;

FIG. 19 is an isometric view of an embodiment of an Automated Feeding System for an Automated Farm with Robots Working on Plants, as described herein;

FIG. 20 is a top view of the embodiment of an Automated Feeding System for an Automated Farm with Robots Working on Plants shown in FIG. 19, as described herein;

FIG. 21 is a side view of the embodiment of an Automated Feeding System for an Automated Farm with Robots Working on Plants shown in FIGS. 19 and 20, as described herein;

FIG. 22 is a section view of the embodiment of an Automated Feeding System for an Automated Farm with Robots Working on Plants shown in FIG. 21, as described herein;

FIG. 23 is an isometric view of an embodiment of a Sorting and Packaging System for an Automated Farm with Robots Working on Plants, as described herein;

FIG. 24 is a perspective view of an embodiment of a Sorting and Packaging System for an Automated Farm with Robots Working on Plants, as described herein;

FIG. 25 is a detail view of a gripper of an embodiment of a Sorting and Packaging System for an Automated Farm with Robots Working on Plants, as described herein;

FIG. 26 is a perspective view of a robot and gripper of an embodiment of a Sorting and Packaging System for an Automated Farm with Robots Working on Plants, as described herein;

FIGS. 27 through 29 are perspective views of grippers of an embodiment of a Sorting and Packaging System for an Automated Farm with Robots Working on Plants, as described herein;

FIG. 30A is a front view of a gripper of an embodiment of a Sorting and Packaging System for an Automated Farm with Robots Working on Plants, as described herein;

FIG. 30B is a side view of a gripper of an embodiment of a Sorting and Packaging System for an Automated Farm with Robots Working on Plants, as described herein; and

FIG. 30C is a perspective view of a gripper of an embodiment of a Sorting and Packaging System for an Automated Farm with Robots Working on Plants, as described herein.

Corresponding reference numbers indicate corresponding parts throughout the several views. The exemplifications set out herein illustrate embodiments of the Automated Feeding, Sorting, and Packaging System for a Farm with Robots Working on Plants, and such exemplifications are not to be construed as limiting the scope of the claims in any manner.

### DETAILED DESCRIPTION

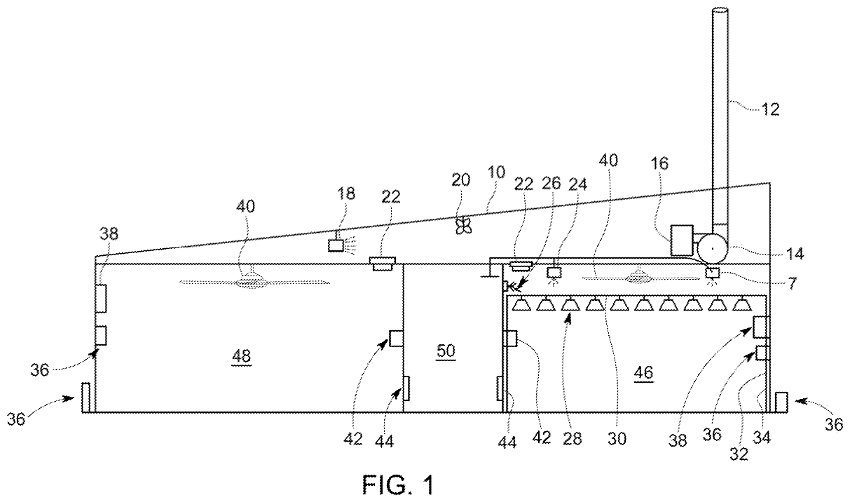

Referring now to FIG. 1, a sectional end view of an embodiment of an Automated Farm with Robots Working on Plants is shown. The farm building is a building with environmentally controlled grow rooms. A single slope roof 10 uses the attic to collect and treat the air that comes out of the grow rooms 46 and 48. Grow room 46 is a flower room with lights 46, and grow room 48 is a flower room without lights 48. In both grow rooms 46 and 48, split HVAC systems 36 have outdoor condensers and indoor heat pumps. Large ceiling fans 40 circulate air throughout the grow rooms 46 and 48, as well as replicate wind which strengthens the plants. Humidifiers and/or dehumidifiers 42 keep the humidity in range if it becomes too low or too high. Room air filters 44 perform a final filtration of the air that gets pulled into the grow rooms 46 and 48 from a preconditioned air hallway 50. The preconditioned air hallway 50 has four air intakes (not shown) from the outside. The four intakes are equipped with heaters, humidification, and filtration controls (not shown). Sensors 38 measure the temperature, humidity, and wind speed in each of the grow rooms 46 and 48. This system is in every grow room as well as in the parent room, to be discussed in further detail herein. The sensors 38 are read incrementally every few seconds and the results are recorded in a database. This gives each plant a history of the atmosphere in which they spent their whole life.

In the flower room with lights 46, there is a CO2 nozzle 24 that enriches and/or fertilizes the cannabis or hemp plants by saturating the flower room with lights 46 with CO2. There is also a spray nozzle 26, which has a dual effect of cooling the flower room with lights 46 and increasing the humidity thereof. Grow lights 28 are arranged in a grid above the plants in the flower room with lights 46. The grow lights 28 are arranged on an automated light rack 30, which is provided with four automated light rack posts 32 located in the corners of the flower room with lights 46. The four automated light rack posts 32 are each equipped with an integrated screw jack 34 that adjusts the automated light rack 30 up and down. In this way, the grow lights 28 may be adjusted in height, in order to avoid burning and damaging the cannabis or hemp plants due to the grow lights 28 being too close to the plants. Additionally, when the grow lights 28 are turned on, they may be turned all the way up and then lowered after several minutes. This more closely replicates the sun when it comes up in the morning. As a result, the plants wake up faster and consume nutrients better which produces more growth.

Each of the grow rooms 46 and 48 is provided with a grow room exhaust fan 22 that exhausts air from the grow rooms 46 and 48 to the attic. Replacement air is thereby pulled into the grow rooms 46 and 48 by way of the room air filters 44 located between the grow rooms 46 and 48 and the preconditioned air hallway 50. Air from the grow rooms 46 and 48 has a pungent odor that needs to be treated prior to exhausting to the outside. The air is therefore filtered by an activated charcoal filter 16 at the intake of an exhaust blower 14, before being exhausted through an exhaust stack 12. In the attic there may be one or more o-zone generators 18, as well as one or more attic circulation fans 20.

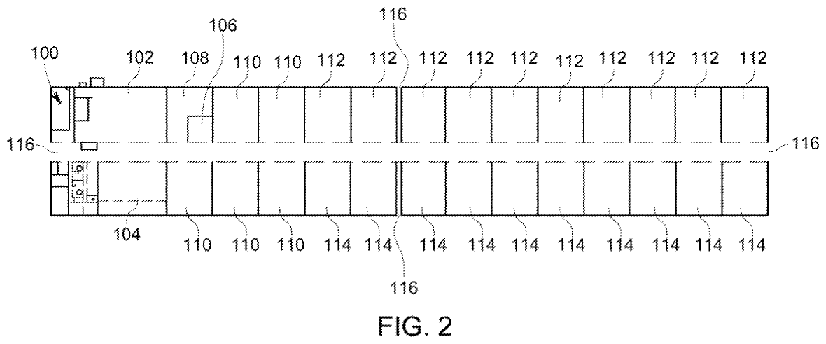

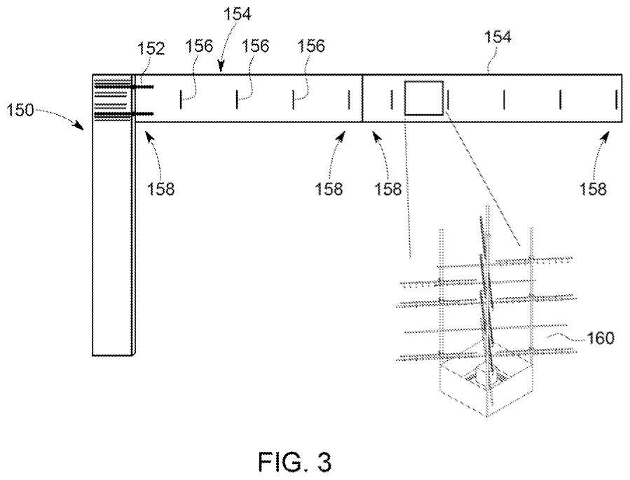

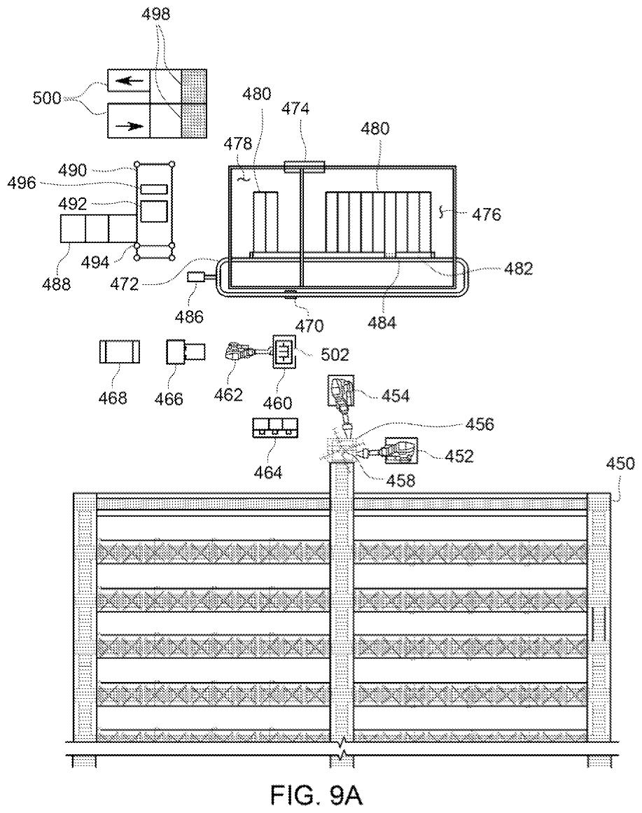

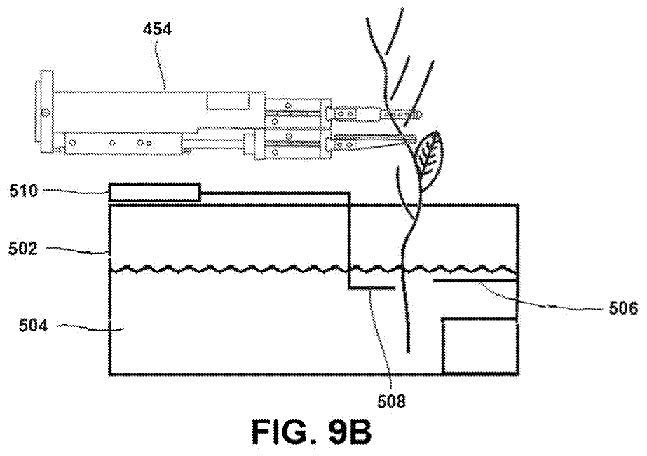

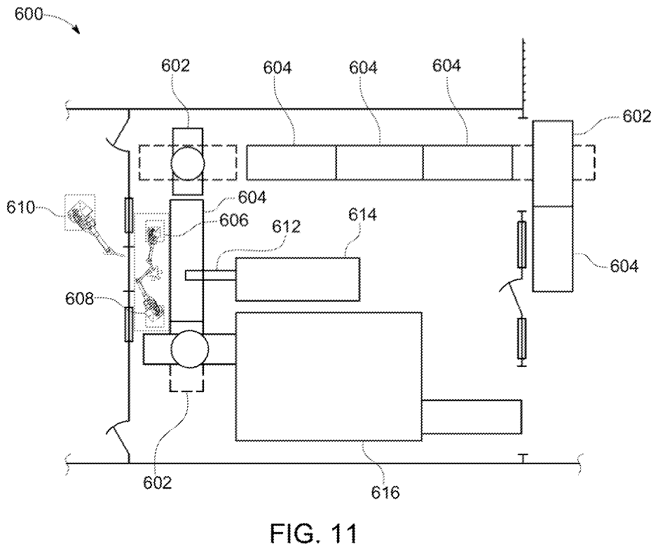

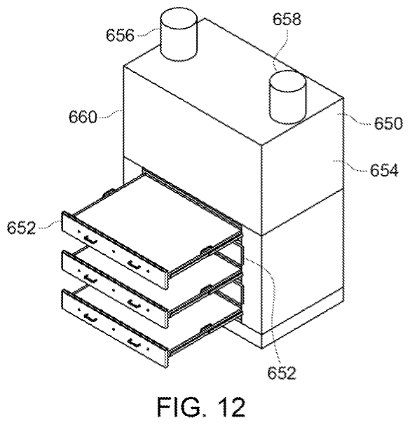

Turning now to FIG. 2, a floor plan of an embodiment of an Automated Farm with Robots Working on Plants is shown. In the embodiment shown, the building is 656 feet long and 120 feet wide, as a non-limiting example. There is a sixteen foot wide main corridor hallway that runs down the middle along the whole length of the building. An equipment and tank room 100 is provided at one end of the building, although it is contemplated that the equipment and tank room 100 may be otherwise located. A clone and parent room 102 and a harvest room 104 are further provided at one end of the building, although it is contemplated that the clone and parent room 102 and/or the harvest room 104 may be otherwise located. The clone and parent room 102 will be described in greater detail hereinafter, and particularly in FIGS. 3 and 9. The harvest room 104 is equipped with equipment needed for harvest, which will similarly be described in greater detail hereinafter, and particularly in FIG. 11. A trimming or pruning room 106 is also provided near the clone and parent room 102 and harvest room 104, although it is contemplated that the trim and pruning room 106 may be otherwise located. The trim and pruning room 106 will be described in greater detail hereinafter. A laboratory 108 may adjoin the trim and pruning room 106, and may contain, for non-limiting example, extraction equipment, and other equipment to make rolled cannabis cigarettes, as well as the equipment to package them.

Next, there are provided, for non-limiting example, five vegetation grow rooms 110 that are similar to flower rooms 112 and 114 except some of the flower rooms have lights, as will be explained herein. The vegetation grow rooms 110 may be located adjacent to the clone and parent room 102, harvest room 104, and/or trim and pruning room 106, although it is contemplated that the vegetation grow rooms 110 may be otherwise located. Each vegetation grow room 110 has trays with, for non-limiting example, sixty plants per tray, although it is contemplated that more or less plants per tray may be used. All of the rest of the grow rooms throughout the farm may have, for non-limiting example, ten plants per tray, although it is contemplated that more or less plants per tray may be used. There are a total of, for non-limiting example, twenty flower rooms 112 and 114. Ten of them are flower rooms with lights 112, and ten of them are flower rooms without lights 114. The flower rooms without lights 114 are directly across from the flower rooms with lights 112. A flowering operation gives the plants twelve hours of light per day. In order to facilitate this, the plants travel back and forth between the flower rooms with lights 112 and the flower rooms without lights 114 every twelve hours. Air intakes 116 are located above overhead doors at the main entrances at each end of the building. The air intakes 116 as described earlier prepare the air that enters the hallway with heat, humidity, and etcetera.

FIG. 3 shows a plan view of a parent power roller conveyor 150 of an embodiment of an Automated Farm with Robots Working on Plants. The parent power roller conveyor 150 is a combination of a powered roller conveyor and a gravity skate wheel conveyor. The parent power roller conveyor 150 brings the parent plants which are grown in a unique parent plant pot 160. The purpose of the parent power roller conveyor 150 is to have a place for the parent plants to live, grow, and be transported to get inspected and fed. The parent power roller conveyor 150 also takes the parent plants to a robot cell for cloning, i.e.—to give up their starts. A chain transfer 152 lifts, turns, and transfers the parent plant pot 160 off the parent power roller conveyor 150 and onto a gravity skate wheel conveyor 154. Palette stops 156 are located along the gravity skate wheel conveyor 154. The palette stops 156 pneumatically raise and lower skate wheels, which stops and positions the parent plant pots 160. The gravity skate wheel conveyor 154 may be provided with a lift mechanism 158. For non-limiting example, there may be a lift mechanism 158 at the end of each ten foot section of gravity skate wheel conveyor 154.

As an example, when a parent plant pot 160 is being transferred into position, it will self-locate along the parent power roller conveyor 150. The chain transfer 152 will lift up, turn, and move the parent plant pot 160 onto the gravity skate wheel conveyor 154. Then the chain transfer 152 will lower, placing the parent plant pot 160 onto the gravity skate wheel conveyor 154. The lift mechanism 158 lifts the gravity skate wheel conveyor 154 under the parent plant pot 160. Gravity rolls the parent plant pot 160 downhill against the first palette stop 156, and then the palette stop 156 lowers so the parent plant pot 160 can move on to the next palette stop 156, and so on. Proximity sensors read the position of the parent plant pot 160, the chain transfer 152 moves up and down, and the palette stops 156 raise and lower as required to place the parent plant pot 160 where desired.

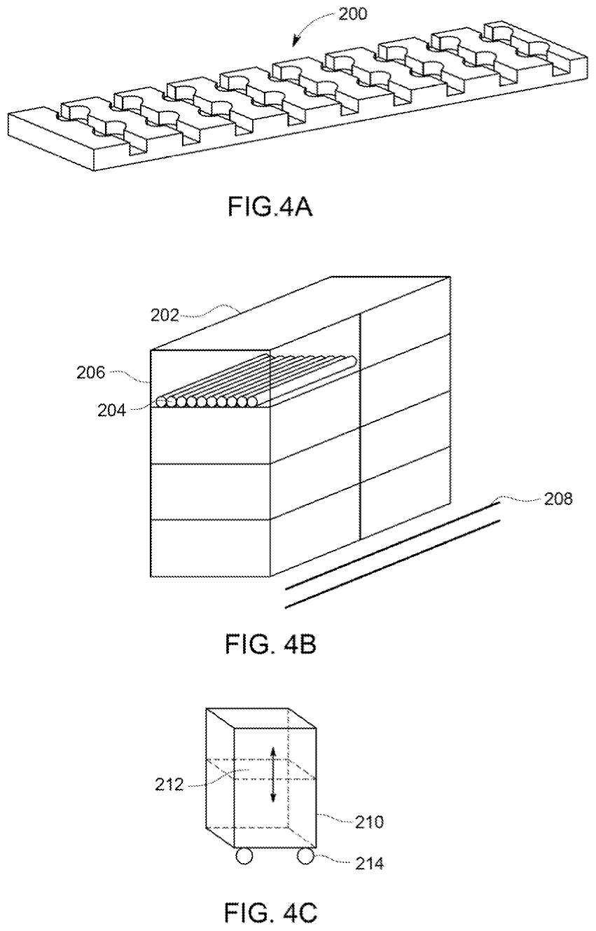

Turning now to FIGS. 4A, 4B, and 4C, an isometric view of a child conveyor tray 200 of a child conveyor of an embodiment of an Automated Farm with Robots Working on Plants is shown. The child conveyor transports such trays of young plants into child storage racks 202 where they grow and are subject to processes such as watering, inspecting, transplanting, and packaging. The child plants are planted in a small cube of soil or Rockwool. The child conveyor tray 200 may have, for non-limiting example, two rows of five holes or cavities for the child plants, so that it is capable of holding ten plants. However, it is contemplated that more or less holes or cavities may be provided, as shown in FIG. 4A. Transverse slots allow room for robot grippers to operate. The child conveyor trays 200 are loaded by clone robots and are transported into a nursery. More details on the operation of such clone robots will be discussed hereinafter, and particularly in FIG. 9. The nursery has multiple child storage racks 202, each of which contain a gravity conveyor 204 and a lifting mechanism 206.

A storage and retrieval system 210 is provided with a track 208, so that the motorized child storage racks 202 are able to traverse the track 208 using powered wheels or powered actuators 214 to their intended destination. Each child storage rack 202 is further provided with at least one movable shelf 212 that raises up-and-down, as well as features that convey the child conveyor trays 200. The at least one movable shelf 212 receives child plants from the gravity conveyor 204 and transfers them to the child storage rack 202 and back as required. The powered wheels 214 and drivetrain of the child storage rack 202 of the storage and retrieval system 210 are used to keep it in position for loading and unloading. The child conveyor control system (not shown) is an industrial Programmable Logic Controller (PLC). The movable shelf 212 and the powered wheels 214 are powered by servomotors (not shown).

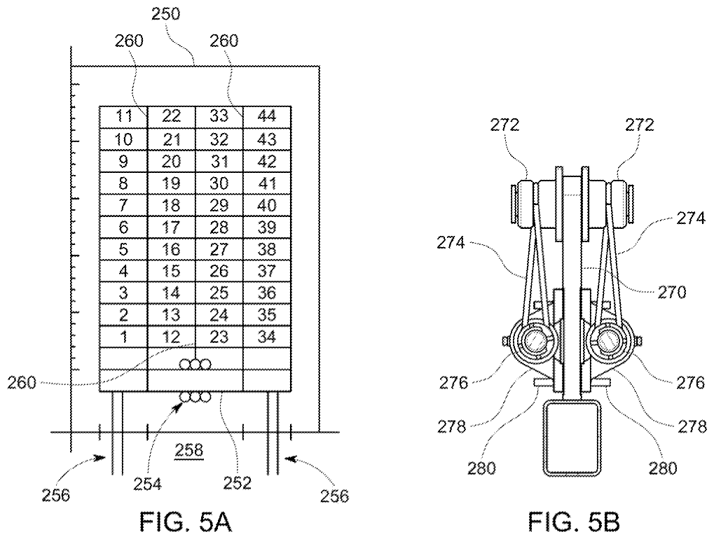

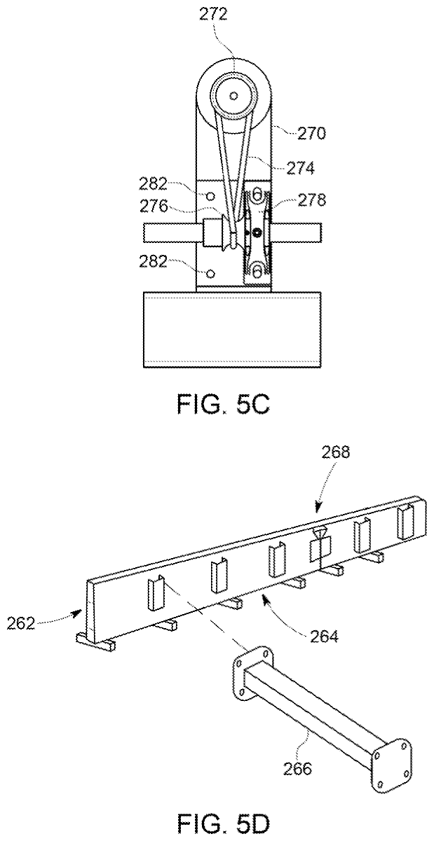

FIG. 5A shows a typical grow room 250 with its conveyor layout. Each grow room 250 may contain 44 trays with ten plants on each tray. Tray sizes, for non-limiting example, may be 40″ by 100″. In the front of the grow room 250, close to the hallway 258, is a section of a conveyor plant testing and watering section 252 that is used for testing the plants and watering them. An automated testing station 254 pneumatically, or using an actuator, inserts probes into the plants' soil to test the moisture, temperature, and electrical current. Electrical current is used to measure the amount of salts left in the soil from the fertilizers. Conveyors 256 extend out into the hallway 258. These conveyors 256 move the trays in and out of the grow room 250. A cross transfer 260 lifts each tray up, and then moves it to the adjacent row. For example, the tray at position 11 is lifted up, whereupon motorized rollers transfer the tray to position 22. Recall from FIG. 2 that there are three types of grow rooms, which in the embodiment of the Automated Farm with Robots Working on Plants shown in FIG. 2 include five vegetation grow rooms, ten flower rooms with lights, and ten flower rooms without lights. The conveyors 256 may be the same for all grow rooms.

FIG. 5D shows a conveyor frame 262, of which there are five in the each of the grow rooms 250. The conveyor frames 262 are assembled using splice-on gussets and fish plates 268. The conveyor frames 262 are fixed in location from each other using offset splice tubes 264 and bolt-on spacer bars 266. The conveyor frames 262 are similar in each instance, except that the outside two conveyor frames 262 only have a single set of rollers and the inside three conveyor frames 262 have two rows of driven rollers. The conveyor frames 262 themselves are the same for both the single roller and double roller sections.

FIGS. 5B and 5C show an embodiment of a roller bracket 270 used in conjunction with the conveyor frames 262, which are in turn part of the conveyor layout of a child conveyor of an embodiment of an Automated Farm with Robots Working on Plants. The roller bracket 270 is of fixed construction, except that it may be provided in two heights, one being for driving the narrow side of the child conveyor trays, and a two inch taller version for driving the wide side of the child conveyor trays. The roller bracket 270 performs the function of holding the axle of two groove rollers 272, which are used to propel the trays. The two groove rollers 272, which may be constructed from plastic, for non-limiting example, are each provided with grooves to receive drive belts 274. The drive belts 274 are, in turn, driven by drive rollers 276. The drive rollers 276 are driven by a motor driven driveshaft, which runs in bearings with two-hole straps 278. Bearings with two hole straps 278 of this type may be sourced from McMaster Carr^{●}, located at 1901 Riverside Pkwy., Douglasville, Ga. 30135-3150, where they are sold as part number 5913K64. Set screws 280 are provided in tapped holes 282 for the purpose of fastening bearings with two-hole straps 278. The control device for the plant conveyors may be an industrial PLC (not shown). Proximity sensors (not shown) track the trays and the movement of the mechanisms. Pneumatics and motors may be used for power.

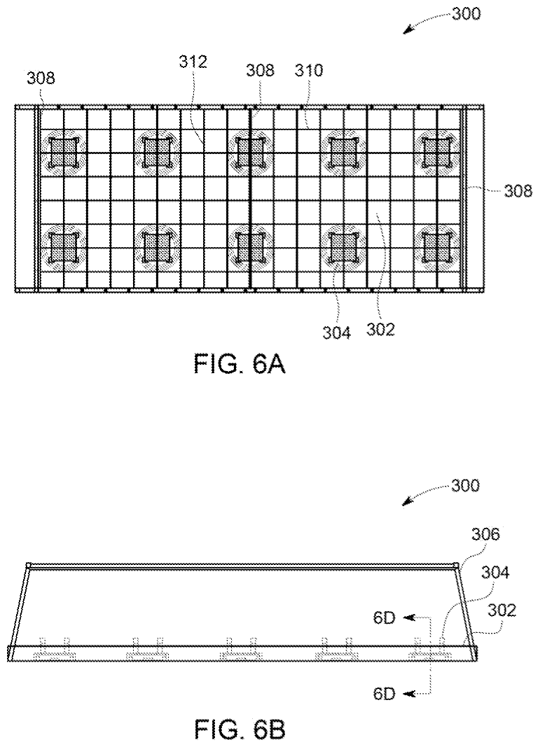

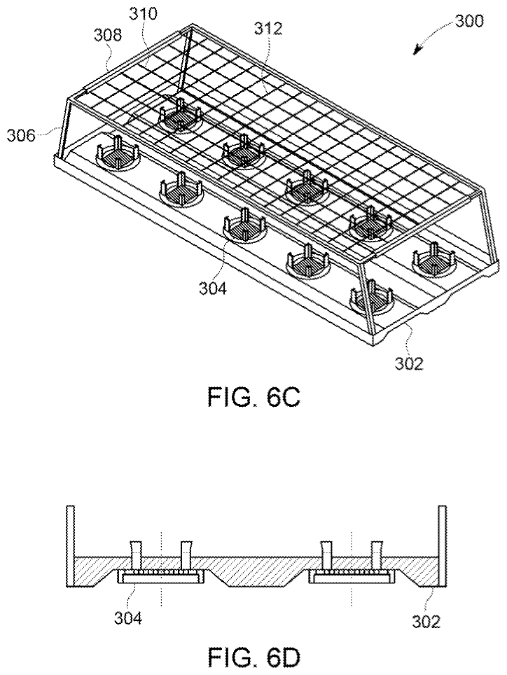

Turning now to FIGS. 6A, 6B, 6C, and 6D, a top view, side view, isometric view, and section view, respectively, of a tray and trellis system 300 of an embodiment of an Automated Farm with Robots Working on Plants is shown. The tray and trellis system 300 includes a tray 302 that holds ten plants, and a trellis frame 306. The tray and trellis system 300 is designed specifically to accommodate automation and has certain unique features for this purpose. The tray 302 uses six inch cubed Rockwool, also known as mineral wool, mineral fiber, or mineral cotton, to grow the plants in, although it is contemplated that other growing media may be used. The Rockwool cubes are placed in rotation holders 304. Each rotation holder 304 is a molded plastic unit that snaps into the tray 302, which may be formed from metal, plastic, or other material. Additional rotating devices (not shown) employed by the Automated Farm with Robots Working on Plants at various points throughout the cloning, trimming or pruning, harvesting, inspecting, and maintaining process have the ability to slightly lift the rotation holder 304 within the tray 302 and rotate the plant which exposes all sides of the plant to robots and cameras as needed.

The tray 302 may be designed to give each plant a 20 inch by 20 inch area to live in, for non-limiting example. The tray 302 may therefore be 100 inches long and 40 inches wide. A trellis frame 306 is connected to the tray 302. Trellises are required for growing cannabis or hemp because, as the flowers develop, the top of the plant gets very heavy and tends to fall over and break. Traditional trellises are hard to use with automation. The typical trellis in use today is made from a unitized grid of string or plastic net. This makes traditional trellises very difficult for robots to work around, especially during harvest. The trellis frame 306 of the present disclosure supports, for non-limiting example, four trellis combs 308, although it is contemplated that more or less trellis combs 308 may be used. Each of the trellis combs 308 has a trellis comb spine 310 and multiple trellis comb ribs 312 attached to the trellis comb spine 310 that are equally spaced apart to create a grid of the desired size. The trellis comb spine 310 and the trellis combs 308 are positioned approximately perpendicular to each other to form a grid. This design allows automated devices to pull the trellis combs 308 out horizontally, thereby releasing the plants for harvest.

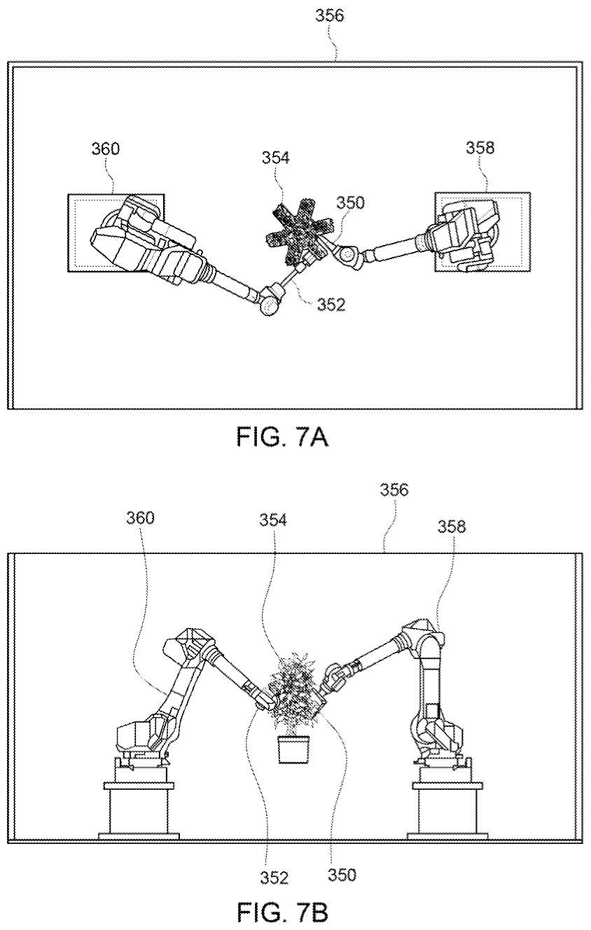

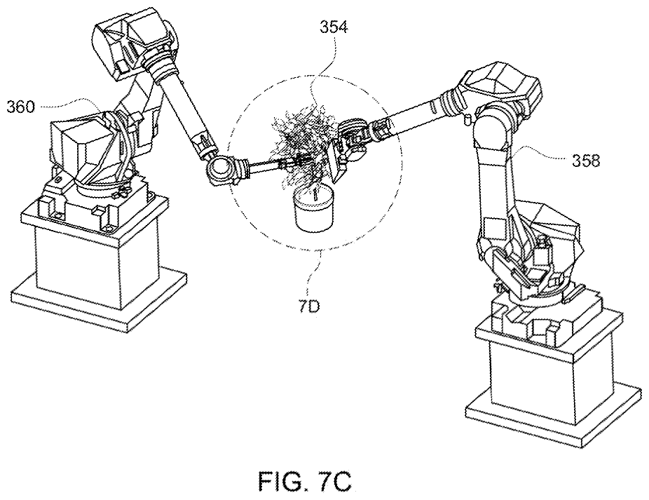

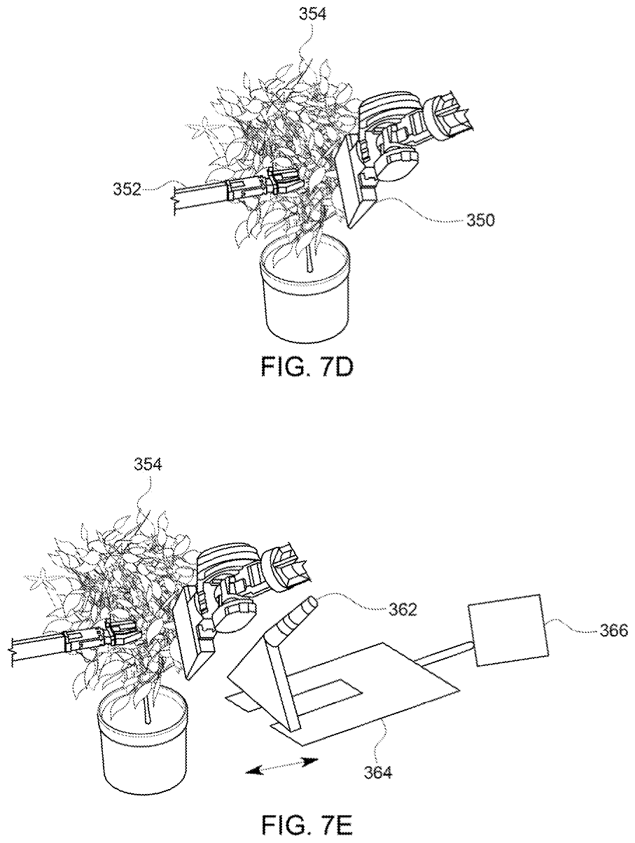

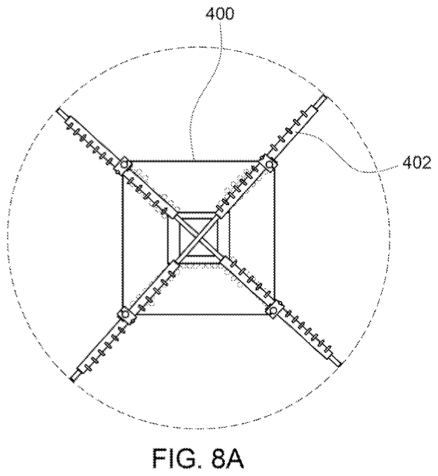

Turning now to FIGS. 7A, 7B, 7C, and 7D, a top view, a side view, an isometric view, and a detail view, respectively, of two robots 358 and 360 of an embodiment of an Automated Farm with Robots Working on Plants are shown. The two robots 358 and 360 are shown working on a cannabis or hemp plant 354 in a room 356. One robot 358 has a lighted tablet or backlight tool 350 that can be inserted into the cannabis or hemp plant 354 to facilitate manipulating its branches, leaves, and flowers. A second robot 360 has a grip-cut tool 352 for cutting and gripping the branches, leaves, and flowers of the cannabis or hemp plant 354, and is further provided with a vision system camera (not shown). The vision system camera may be attached to the grip-cut tool 352, or may be attached elsewhere to the grip-cut tool holding robot 360.

The grip-cut tool holding robot 360 generally maintains a position perpendicular and centered to the backlight tablet tool 350 held by the backlight tablet tool holding robot 358. The backlight tablet tool holding robot 358 systematically moves the backlight tablet tool 350 through the plant while the camera of the grip-cut tool holding robot 360 looks for an ideal cloning, trimming or pruning, harvesting, and/or maintaining situation. When the ideal cloning, trimming or pruning, harvesting, and/or maintaining situation presents itself to the vision system, the backlight tablet tool holding robot 358 stops and the grip-cut tool holding robot 360 moves in a perpendicular motion to the backlight tablet tool 350, towards the plant. The grip-cut tool holding robot 360 grips the cannabis or hemp plant 354 and cuts the branch, leaf, or flower to be removed.

FIG. 7E further shows a trim recovery system 362, which is used to collect scrap material generated as the backlight tablet tool holding robot 358 and the grip-cut tool holding robot 360 perform their cloning, trimming or pruning, harvesting, and/or maintaining functions. The trim recovery system 362 vacuums up materials that have been cut from the cannabis or hemp plant 354. In at least one embodiment, this is accomplished by extending a catch tray 364 while the backlight tablet tool holding robot 358 and the grip-cut tool holding robot 360 are performing their tasks. When the backlight tablet tool holding robot 358 and the grip-cut tool holding robot 360 have completed trimming or pruning, a catch tray actuator 366 retracts the catch tray 364. As the catch tray 364 retracts a vacuum (not shown) sweeps up all of the debris that is left on the catch tray 364.

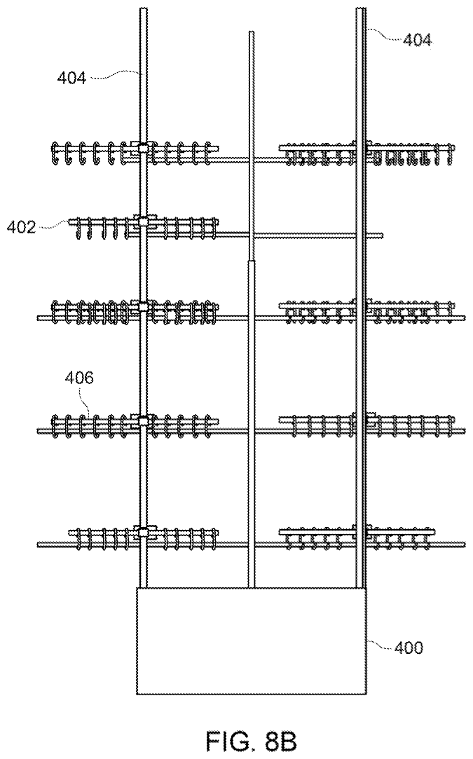

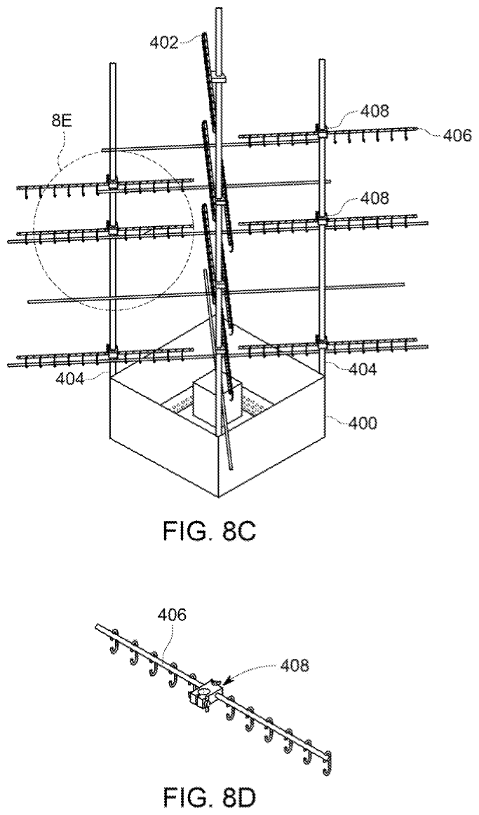

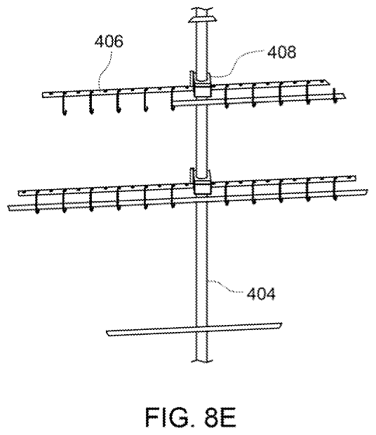

Turning now to FIGS. 8A, B, C, D, and E, a top view, side view, isometric view, detail view, and detail view, respectively, of a parent plant pot and training tools assembly of an embodiment of an Automated Farm with Robots Working on Plants is shown. The parent plant pot and training tools assembly includes a parent plant pot 400 that a parent cannabis or hemp plant (not shown) will grow in, as well as a training system 402 for shaping the parent cannabis or hemp plants and guiding them to grow in a more convenient form. Parent cannabis or hemp plants are used to provide new shoots or starts, which are cut therefrom. These cuttings are then used to clone new cannabis or hemp plants. This operation guarantees that all of the cannabis or hemp plants started from clones have the same genes as their parent cannabis or hemp plants. This has several advantages including adapting and expanding as the plants grow and mature. Cannabis and hemp plants grow with their branches angled upward. When the cannabis or hemp plants are mature and large, their foliage can be dense and hard to manipulate automatically. It is advantageous to automation equipment to provide horizontal branches with starts growing upwards towards the lights.

To accomplish this, the parent plant pot and training tools assembly includes a parent plant pot 400, which may be square in shape, although the use of other shapes is contemplated. The parent plant pot 400 may be of pot metal construction, for non-limiting example, with a perforated bottom that allows water and nutrients to pass therethrough. However, it is contemplated that the parent plant pot 400 may be constructed from other materials. The parent plant pot 400 also has features that secure four corner posts 404. For non-limiting example, there may be four corner posts 404 that slide into pockets on the pot (not shown). These corner posts 404 provide a foundation for a number of training arms 406. Each training arm 406 is provided with an adjustable clamp 408 that allows the training arm 406 to slide up and down the corner post 404. The adjustable clamp 408 further allows the training arm 406 to rotate around the corner post 404. Common plant tying materials may then be used to tie the parent cannabis or hemp plant to the training arm 406. In at least one embodiment, each training arm 406 may be provided with clips, as depicted in FIGS. 8A through 8E. The training arms 406 may, for non-limiting example, be made from metal or fiberglass or other plastic materials.

FIG. 9 shows a top view of a cloning and parent plant room layout of an embodiment of an Automated Farm with Robots Working on Plants. A parent plant conveyor 450 is shown having four and a half rows of parent cannabis or hemp plants 458 for the sake of illustration. However, it is to be understood that a cloning and parent plant room layout of a given embodiment of an Automated Farm with Robots Working on Plants may have, for non-limiting example, fifty rows with twenty parent cannabis or hemp plants 458 in each row, for a total of one thousand parent cannabis or hemp plants 458. The parent cannabis or hemp plants 458 live in a controlled environment under special lighting on the parent plant conveyor 450, as shown previously. The parent cannabis or hemp plants 458 may be transported using the parent plant conveyor 450 to the watering station (not shown in FIG. 9), the inspection station (not shown in FIG. 9), and to the backlight tablet tool holding robot 452 and grip-cut tool holding robot 454 for cloning and trimming or pruning during the cloning process.

The backlight tablet tool holding robot 452 and the grip-cut tool holding robot 454 perform operations on the cannabis or hemp plant 458 upon a roller conveyor turn table 456, which receives the cannabis or hemp plant 458 from the parent plant conveyor 450. Specifically, the backlight tablet tool holding robot 452 locates a start to be taken from the parent cannabis or hemp plant 458 by the grip-cut tool holding robot 454. Once the clone has been removed from the parent cannabis or hemp plant 458, the grip-cut tool holding robot 454 takes the clone to a clone preparation tank 502 mounted on a clone planting pedestal 460 that contains a rooting hormone solution 504. The grip-cut tool holding robot 454 dips the clone in the clone preparation tank 502. While the clone is submerged, two blades 506 and 508, one fixed blade 506 that is fixed to the clone preparation tank 502 and a movable blade 508 that is on an actuator 510, work together to rough up the bottom of the stem so the clone has a better interaction with the rooting hormone solution 504. Then the grip-cut tool holding robot 454 moves the clone over onto clone planting pedestal 460. Then the grip-cut tool holding robot 454 places the clone in a Rockwool plug that has been prepared by a Rockwool plug robot 462.

The Rockwool plugs come to the operation in large totes. A tote full of plugs is dumped as needed into a flex feeder 466 by a tote dumper 468. The flex feeder 466 has a backlit bottom that shakes up and down to randomly arrange plugs for the Rockwool plug robot's vision system. The flex feeder 466 presents the Rockwool plugs to the Rockwool plug robot 462. The Rockwool plug robot 462 picks up the plug and rinses it in the three solutions in pH controlled rinse tanks 464. Then the Rockwool plug robot 462 places the Rockwool plug on the clone planting pedestal 460 where the grip-cut tool holding robot 454 inserts the clone into the Rockwool plug. The Rockwool plug robot 462 then puts the planted clone in a child tray 470 located on the child conveyor 472.

A nursery has two separate chambers, a first larger nursery chamber 476 for newly planted clones, and a second nursery chamber 478 for more developed clone child cannabis or hemp plants. Each of the nursery chambers is provided with temperature and humidity controls 474. The second nursery chamber 478 has less humidity than the first nursery chamber 476, and prepares the more developed clone child cannabis or hemp plants for the grow rooms. Plant racks 480 in the first and second nursery chambers 476 and 478 provide a location for the cloned cannabis or hemp plants to grow, and are provided four levels each for this purpose. The bottom of each level of the plant rack 480 has gravity skate wheels for the child tray 470 to ride on. A lifting device (not shown) at the back of each plant rack 480 lifts one end of the bottom of each level up causing the gravity skate wheels to shuttle the child trays 470 out as needed.

A transporter track 482 along the front of the plant racks 480 is provided with a transporter 484 that moves back-and-forth across the front of the plant racks 480. The transporter 484 is provided with a shelf (not shown) that moves up and down to the four levels of the plant racks 480. In order to put a child tray 470 of newly planted clones into a plant rack 480, the transporter 484 positions itself in front of that plant rack 480. The shelf of the transporter 484 then raises to the correct level and transfers the child tray 470 to the plant rack 480 by pushing the child tray 470 into the plant rack 480. The shelf of the transporter 484 has the ability to move a child tray 470 in and out of the plant rack 480 as well as on and off of the child conveyor 472.

When the cloned cannabis or hemp plants are fully mature, they may be sold or moved to grow rooms either in trays of small Rockwool plugs or in trays of Rockwool plugs that have been transplanted into their larger Rockwool cube. The system for preparing Rockwool cubes includes a conveyor 488 that conveys pallets full of Rockwool cubes, which are 6″×6″×6″ in size. A gantry frame 490 has a gantry head with integrated shelf 494, and is used to move a row of cubes. A top layer pusher and scissor lift 492 separates a layer of Rockwool cubes and moves them to preparation tanks 496. A transplant robot 486 then moves completed clones to the trays or to Rockwool cubes. Finally the completed clones are staged in dunnage 498 and prepared for delivery using a conveyor 500.

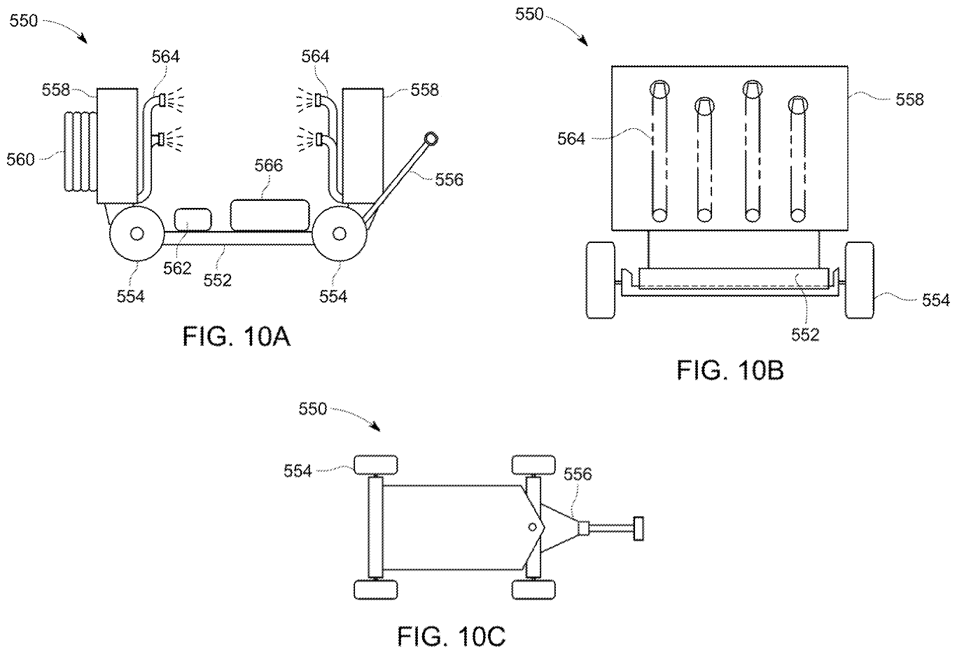

Turning now to FIGS. 10A, 10B, and 10C, a portable spray station 550 is shown having a lightweight frame 552 and wheels 554, and is approximately six feet wide. The portable spray station 550 is provided with a handle 556, so that a person can pull the portable spray station 550 similar to a wagon. The portable spray station 550 is further provided with a fluid tank and pump system 558, a compressor tank 566, and an air hose and control power cord 560. In this way, the portable spray station 550 may be plugged into a power and air supply between rooms, whereupon the portable spray station 550 may lock into sockets in the floor. A control system 562 is provided, as well as spray nozzles 564, of which there may be four, for non-limiting example. The four spray nozzles 564 may positioned to spray the cannabis or hemp plants as they pass down the conveyor. For non-limiting example, there may be twelve inches between sprayer columns.

Room is provided between the four spray nozzles 564 for a door or section of a conveyor to drop into, whereupon photo eyes (not shown) of the control system 562 activate the portable spray station 550. In this way, the portable spray station 550 is used to spray material on cannabis or hemp plants for their well-being. It can also be used to clean the cannabis or hemp plants. The portable spray station 550 can be positioned at many points in the farm. As noted previously, the portable spray station 550 is able to locate under a conveyor section where the plants will pass. In this way, portable spray station 550 is able to spray the plants as they pass down the conveyors, or as they cross a hallway.

Turning now to FIG. 11, a plan view of an automated harvesting cell 600 of an embodiment of an Automated Farm with Robots Working on Plants is shown. In the automated harvesting cell 600, trays of cannabis or hemp plants are transported by standard conveyor sections 604 to the harvest room. In order to change the direction of motion of the trays of plants, a conveyor turntable 602 may lift and rotate a pallet full of plants. Further standard conveyor sections 604 and conveyor turntables 602 position the cannabis or hemp plants front of a backlight tablet tool holding robot 606, a grip-cut tool holding robot 608, and/or a trimming or pruning robot system 610, which cooperate to remove flowers and any other unwanted parts of the cannabis or hemp plants. These wanted and unwanted cannabis or hemp plant parts are sorted and put in their proper place for further processing. Meanwhile, the grip-cut tool holding robot 608 discards used Rockwool to a conveyor 612 that leads to a Rockwool baler 614. The Rockwool baler 614 is a baler that compresses the used Rockwool, making it easier to discard. The empty tray, in turn, proceeds by way of a standard conveyor section 604 and another conveyor turntable 602 to a tray wash and dry system 616.

FIG. 12 shows a curing cabinet 650 having five drawers 652. It is contemplated that the number and relative size of the drawers 652 of the curing cabinet 650 may vary. The curing cabinet 650 conditions the buds or flowers taken from the cannabis or hemp plants so that they are more pleasant to smoke. Curing the buds or flowers takes time and is aided by heating and cooling cycles, as well as application of the proper humidity. The top of the curing cabinet 650 contains an air exchange system 654 having an intake filter 656 and a charcoal exhaust filter 658. The air exchange system 654 circulates exchange air around the buds or flowers as they are sitting in the drawer 652 on a screen. A control system 660 based on an industrial PLC is programmable to implement a complete curing cycle over many days, for each drawer 652 of buds or flowers. The drawers 652 of the curing cabinet 650 each have a lift out screen mentioned previously for promoting circulation and for handling the buds or flowers.

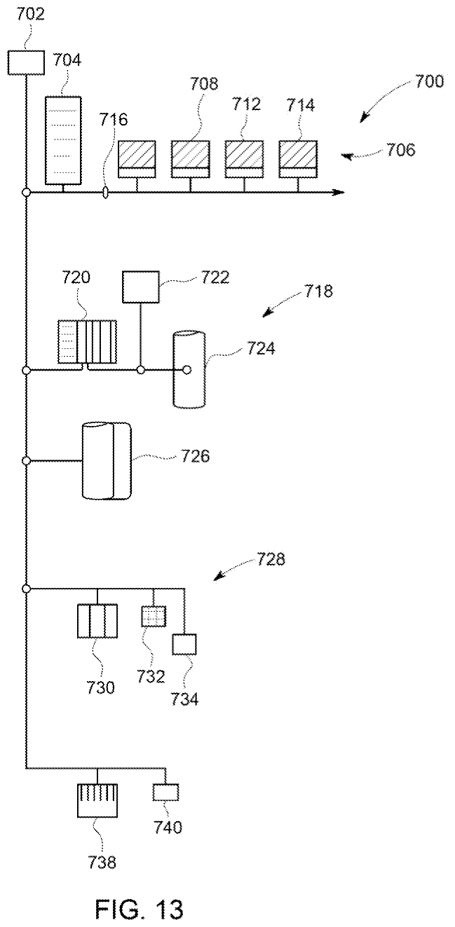

FIG. 13 shows a graphic representation of a farm control and data management system of an embodiment of an Automated Farm with Robots Working on Plants. The farm control and data management system is based on a control system network 700 that is connected to a farm server 704. The control system network 700 has a modem 702 and an Ethernet 716, as well as several office PCs 706, which may include, as non-limiting examples, an office PC for each of a farm manager 708, technical support 710, a master gardener 712, and sales 714. The control system network 700 may further be connected to, as a non-limiting example, a cloning cell 718 having a programmable logic controller 720 for the robots and other equipment, a robot vision controller 724, and a human machine interface 722. The cloning cell 718 shown in FIG. 13 is representative, such that multiple similar arrangements may be provided for planting cells, pruning or trimming cells, and harvesting cells, and tray wash cells, for non-limiting example.

Similarly, the control system network 700 may further be connected to room controllers 728 having programmable logic controllers 730 for the robots and other equipment, robot vision systems 734, and human machine interfaces 732. Multiple similar arrangements may be provided for rooms having conveyors, fans, watering stations, testing stations, spray stations, and/or inspection cameras. The control system network 700 may further be connected to a hallway conveyor control 736 having a programmable logic controller 738 and a human machine interface 740. A main programmable logic controller 726 may be provided to coordinate the functions of the Automated Farm with Robots Working on Plants, as well as to control miscellaneous functions such as lighting control, CO2 control, HVAC control, and/or humidity control. Generally, the control system network 700 operates all aspects of the farm automation. The control system network 700 may also log a large amount of data including atmospheric conditions and pictures of the plants.

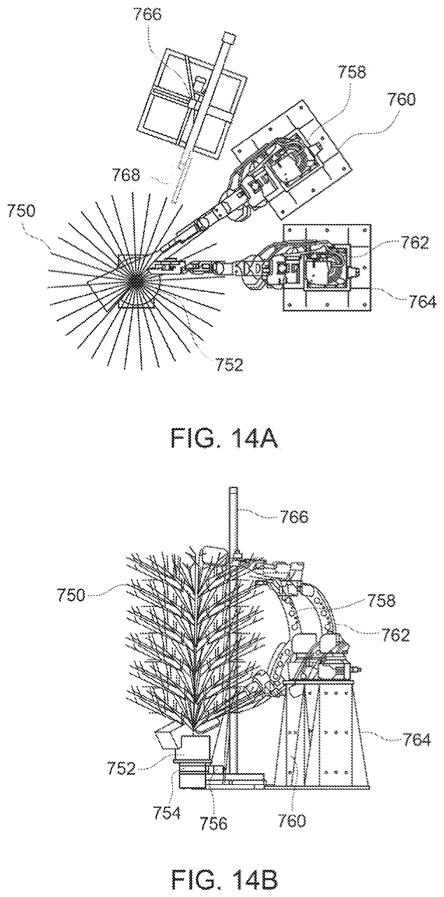

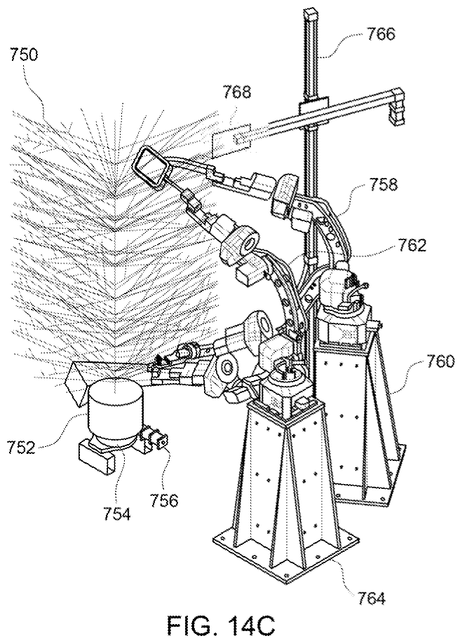

Turning now to FIGS. 14A, 14B, and 14C, a top view, a side view, and an isometric view, respectively, of two robots 758 and 762 of an embodiment of an Automated Farm with Robots Working on Plants are shown. As part of the process, a cannabis or hemp plant 750 in a parent plant pot 752 is placed on a parent plant pot turntable 754 having a pot rotating motor 756. A backlight tablet tool holding robot 758 is mounted on a backlight tablet tool holding robot pedestal 760, and a grip-cut tool holding robot 762 is mounted on a grip-cut tool holding robot pedestal 764. As before, the grip-cut tool holding robot 762 generally maintains the grip-cut tool in a position perpendicular and centered to the backlight tablet tool held by the backlight tablet tool holding robot 758. The backlight tablet tool holding robot 758 systematically moves the backlight tablet tool through the plant while the camera of the grip-cut tool holding robot 762 looks for an ideal cloning, trimming or pruning, harvesting, and/or maintaining situation. When the ideal cloning, trimming or pruning, harvesting, and/or maintaining situation presents itself to the vision system, the backlight tablet tool holding robot 758 stops and the grip-cut tool holding robot 762 moves in a perpendicular motion to the backlight tablet tool, towards the plant. The grip-cut tool holding robot 762 grips the cannabis or hemp plant 750 and cuts the branch, leaf, or flower to be removed.

Additionally, a plant manipulator 766 is provided. The plant manipulator's positioning is controlled by two servo-motors (not shown). The plant manipulator 766 reaches into the plant using a manipulator attachment 768 as the parent pot turntable 754 moves, thereby pushing the plant's branches against the manipulator attachment 768. This action opens an area for the backlight tablet tool holding robot 758 and the grip-cut tool holding robot 762 to work on the cannabis or hemp plant 750, thereby further facilitating the process of cloning, trimming or pruning, harvesting, inspecting, and maintaining.

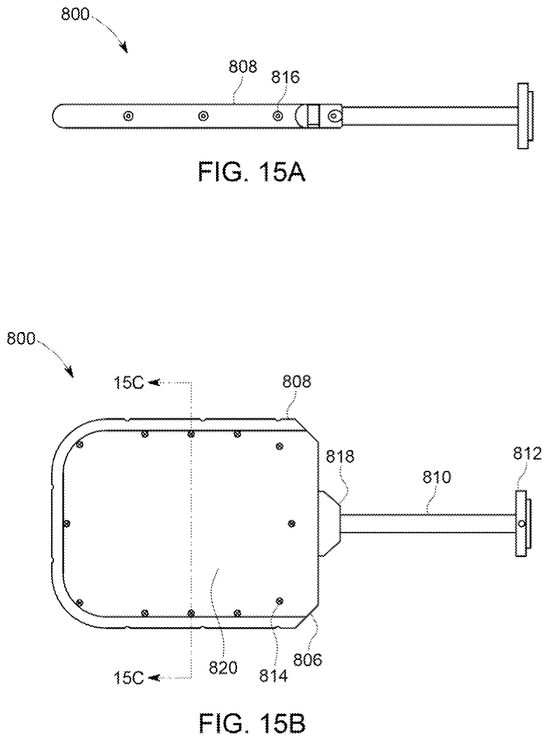

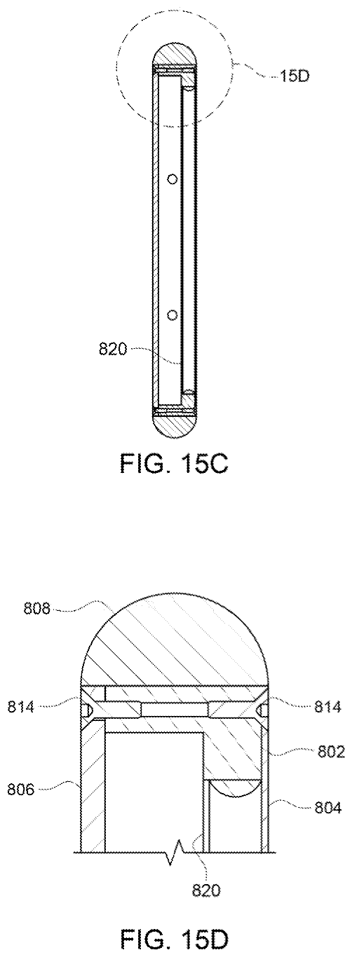

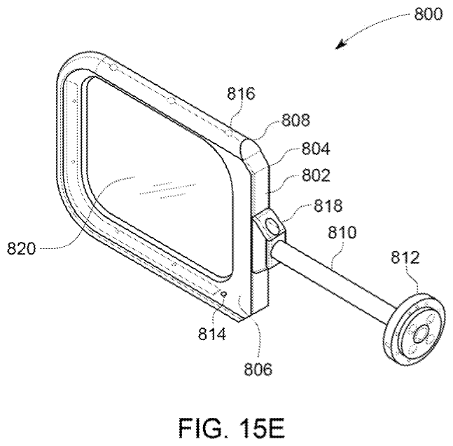

Turning now to FIGS. 15A, 15B, 15C, 15D, and 15E, a top view, a front view, a sectional end view, a detail view, and an isometric view, respectively, of a backlight assembly 800 of an embodiment of an Automated Farm with Robots Working on Plants is shown. A backlight enclosure plate 802, a backlight backing plate 804, and a backlight cover plate 806 defines a cavity containing a backlight screen 820. The backlight backing plate 804 and the backlight cover plate 806 are attached to the backlight enclosure plate 802 using Torx flat head screws 814. Backlight edging 808 is attached to the outward periphery of the backlight enclosure plate 802 using socket head cap screws 816, in order to protect the backlight assembly 800 as it is maneuvered within the cannabis or hemp plant. A backlight adapter 818 connects the backlight enclosure plate 802 to a backlight robot adapter extension 810, which is in turn connected to a backlight robot adapter 812. The backlight robot adapter 812 connects the backlight assembly 800 to the backlight tablet tool holding robot (not shown).

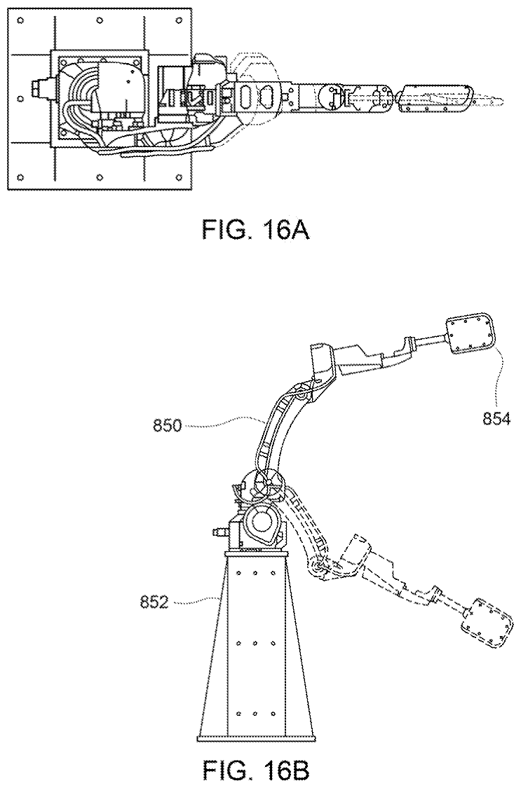

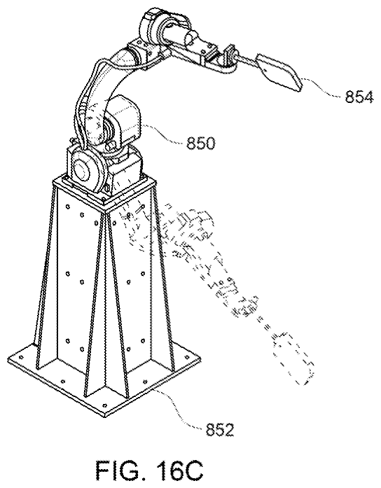

FIGS. 16A, 16B, and 16C, in turn, show a top view, a side view, and an isometric view, respectively, of a backlight tablet tool holding robot 850 of an embodiment of an Automated Farm with Robots Working on Plants. The backlight tablet tool holding robot 850 is shown in two different articulated positions, in order to illustrate a range of motion of the backlight tablet tool holding robot 850. The backlight tablet tool holding robot 850 is mounted on a backlight tablet tool holding robot pedestal 852. A backlight assembly 854 as shown in FIGS. 15A through 15E is connected to the backlight tablet tool holding robot 850.

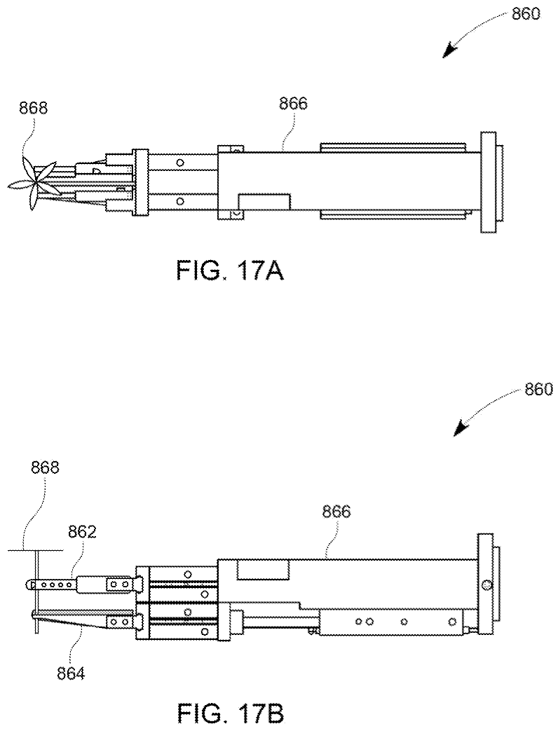

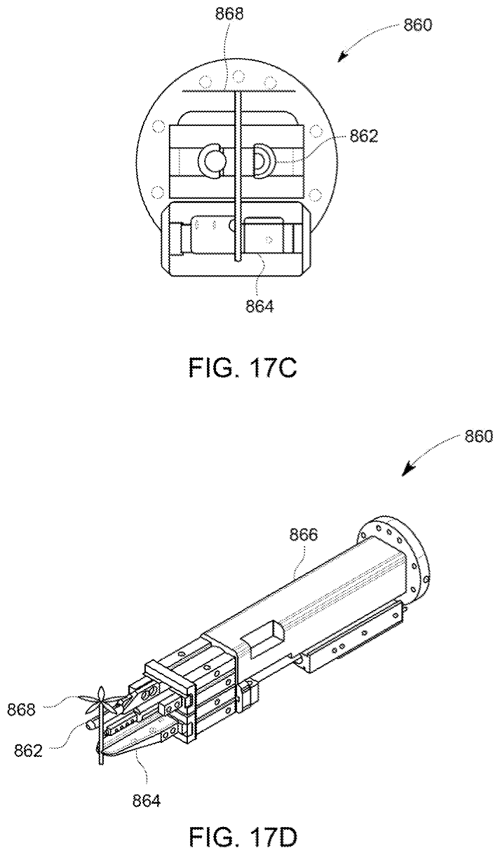

Turning now to FIGS. 17A, 17B, 17C, and 17D, a top view, a side view, an end view, and an isometric view, respectively, of a grip-cut tool 860 of an embodiment of an Automated Farm with Robots Working on Plants is shown. The grip-cut tool 860 is provided with a plant sensor 862, which is used to verify the location of the cannabis or hemp plant 868 when preparing to grip or cut it. The grip-cut tool 860 is further provided with a grip-cutter 864, which is actuated by a grip-cutter actuator 866.

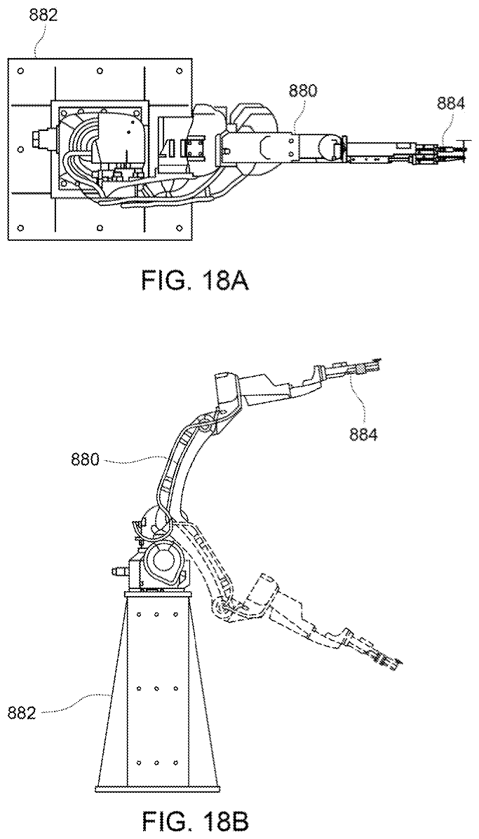

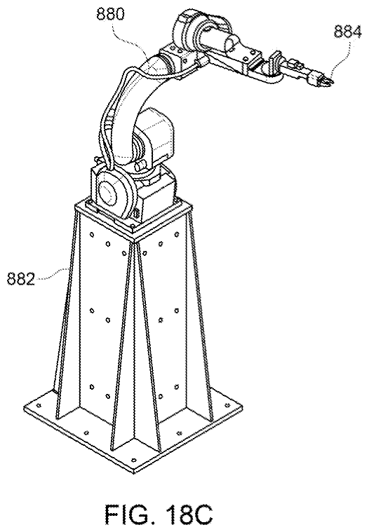

FIGS. 18A, 18B, and 18C, in turn, show a top view, a side view, and an isometric view, respectively, of a grip-cut tool holding robot 880 of an embodiment of an Automated Farm with Robots Working on Plants. The grip-cut tool holding robot 880 is shown in two different articulated positions, in order to illustrate a range of motion of the grip-cut tool holding robot 880. The grip-cut tool holding robot 880 is mounted on a grip-cut tool holding robot pedestal 882. A grip-cut tool 884 as shown in FIGS. 17A through 17D is connected to the grip-cut tool holding robot 880.

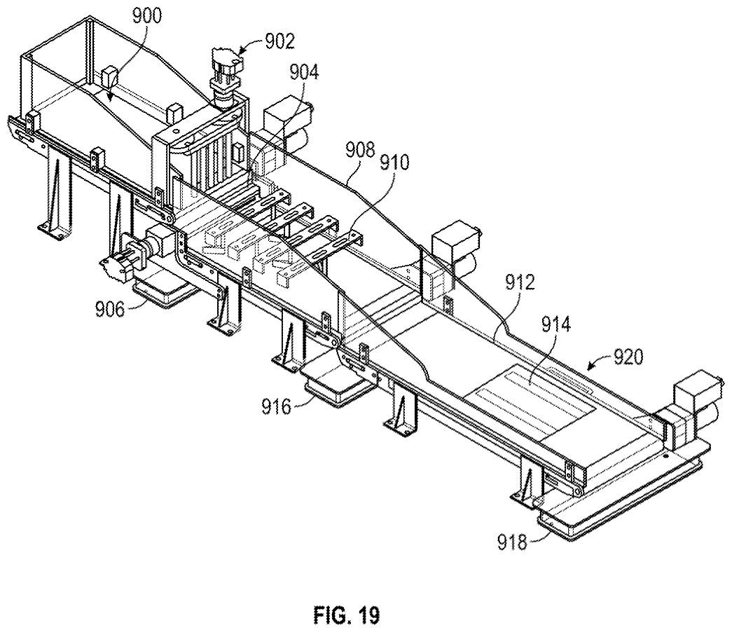

Turning now to FIGS. 19, 20, and 21, an embodiment of the Automated Feeding System for a Farm with Robots Working on Plants is shown. Cannabis or hemp buds and/or flowers are placed onto a hopper conveyor belt 900 that has a conveyor in the bottom of it. The hopper conveyor belt 900 then feeds material forward very slowly. The hopper conveyor belt 900 feeds a diverter conveyor belt 908 which is moving slightly faster, in order to evenly spread the material. At the end of the hopper conveyor belt 900, there is an orbital rake separator 902 that also helps to gently spread and separate the buds. The orbital rake separator 902 is mounted so teeth or rods extend down vertically and can move in a circular side to side, upstream, and/or downstream motion. Similar orbital rake separators may be provided in additional locations along the hopper conveyor belt 900 and/or along the diverter conveyor belt 908, in order to achieve the desired spread of material. The motion of the orbital rake separator 902 advantageously separates and spins long buds that tend to jam static separation tools.

Between the hopper conveyor belt 900 and the diverter conveyor belt 908, there is a size separation tool 904 which is a finned tube that can have various sized slits or pockets, depending upon the size of material that needs to be separated. The tube of the size separation tool 904 slowly rotates and prevents smaller material such as leaf pieces, kief, and small buds from dropping on the diverter conveyor belt 908. Instead, the smaller material drops between and beneath the hopper conveyor belt 900 and the diverter conveyor belt 908 into a separated product catch pan 906 or onto another conveyor or machine that move the product to another process. The size separation tool 904 may rotate in the same direction as the hopper conveyor belt 900 and the diverter conveyor belt 908, although it is contemplated that the size separation tool 904 may rotate in the opposite direction from the hopper conveyor belt 900 and the diverter conveyor belt 908. Furthermore, the size separation tool 904 may be controlled in such a way that it alternates between rotating in same direction as the hopper conveyor belt 900 and the diverter conveyor belt 908 and in the opposite direction from the hopper conveyor belt 900 and the diverter conveyor belt 908. In such an embodiment, the ratio of rotations in same direction as the hopper conveyor belt 900 and the diverter conveyor belt 908 and in the opposite direction from the hopper conveyor belt 900 and the diverter conveyor belt 908 may be variable, according to the characteristics of the flowers and/or buds.

For non-limiting example, in order to catch material approximately ⅜″ and smaller, the slits or pockets on the wheel of the size separation tool 904 are arranged to be about ⅜″ in size, so that the size separation tool 904 catches the material ⅜″ and smaller as the material falls off the diverter conveyor belt 908. Accordingly, size separation tools 904 may be interchangeable, and may be provided with slits or pockets of various sizes according to the threshold material size desired. Since the larger buds will not fit into the slits or pockets of the size separation tool 904, the larger material will bounce off onto the diverter conveyor belt 908. In order to minimize product or material from adhering to the size separation tool 904, the Automated Feeding System may include an air ionizer located above the size separation tool 904. The air ionizer may reduce static charge accumulation on the product or material and on the size separation tool 904, so that the size separation tool 904 more efficiently separates the material and deposits the leaf pieces, kief, and small buds into the separated product catch pan 906.

The diverter conveyor belt 908 may have static diverter posts 910 to further separate the buds. The static diverter posts 910 are suspended just above the diverter conveyor belt 908. As the diverter conveyor belt 910 transports the buds, they come in contact with the static diverter posts 910 and are deflected as desired. At the end of the diverter conveyor belt 908, the cannabis or hemp flowers and/or buds fall onto a pickup conveyor belt 912. This pickup conveyor belt 912 moves slightly faster to further separate buds. The pickup conveyor belt 912 may be arranged to take the material to any additional process. Additional conveyors may be added to further improve separation. As needed, the pickup conveyor belt 912 may be provided with a front lit or back lit pickup location 914 for robot vision purposes. Specifically, the pickup conveyor belt 912 may be lit from directly above, or adjacent, the belt surface with lights of an intensity arranged to assist a vision guided robot in locating and picking up the cannabis or hemp flowers and/or buds. In a back lit configuration, the pickup conveyor belt 912 may be semi-transparent, so that when it passes over the back lit pickup location 914, the cannabis or hemp flowers and/or buds are lit from underneath, to further assist the vision guided robot in locating and picking up the cannabis or hemp flowers and/or buds.

The hopper conveyor belt 900, the diverter conveyor belt 908, and/or the front lit or back lit pickup conveyor belt 912 may even pause when the arrangement senses that material is about to fall off the pickup conveyor belt 912. Alternately, or conjunction therewith, if a flower or bud is too large or too small, the hopper conveyor belt 900, the diverter conveyor belt 908, and/or the front lit or back lit pickup conveyor belt 912 may continue, allowing the too large or too small flower or bud to fall into another bin. This allows a worker or automated machinery to remove flowers and/or buds of acceptable size from the pickup conveyor belt for further processing. The pickup conveyor belt 912 may be provided with a backlight service door 920 to service the light for the back lit pickup location 914.

All conveyors belts may be provided with a conveyor belt scraping mechanism positioned above separated product catch pans 906, 916, and 918 to remove product from the conveyor belts. The belt scraping mechanism may also remove static electricity from the conveyor belts to further assist with product release. Moreover, the belt scraping mechanism may also induce static electricity upon the conveyor belts, and/or the system may induce static electricity upon other system components, in order to assist with product movement. The Automated Feeding System for a Farm with Robots Working on Plants may be arranged with multiple tiers of sorting, including further diverter conveyor belts, orbital rake separators, size separation tools, static diverter posts, and product catch pans. In this way, the product is separated incrementally, starting with the smallest material being separated, below which another line separates the medium material, and below which larger material is separated.

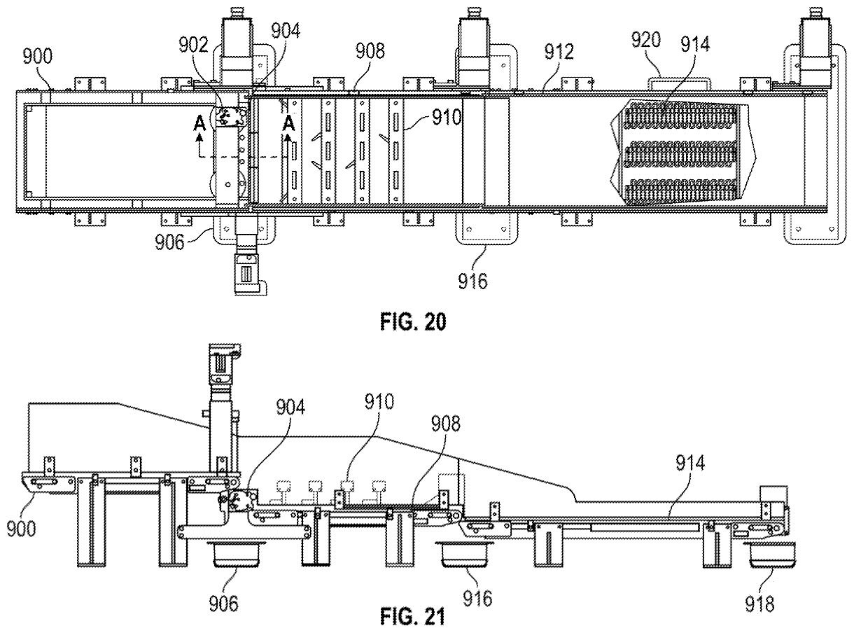

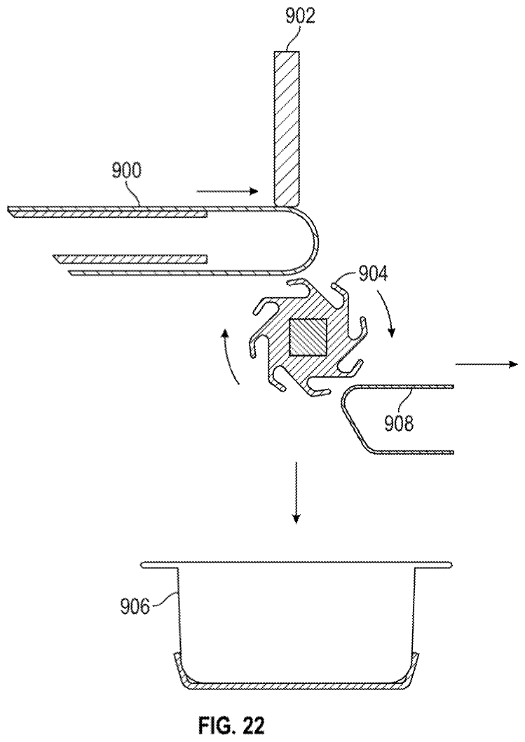

Turning now to FIG. 22, a section view is shown of the embodiment of the Automated Feeding System for a Farm with Robots Working on Plants shown in FIGS. 19, 20, and 21, as taken along section line A-A in FIG. 20. According to an embodiment of the process of using the Automated Feeding System for a Farm with Robots Working on Plants, in a first step, cannabis or hemp flowers are again placed onto the hopper conveyor belt 900, which moves the product forward towards the orbital rake separator 902. In a second step, the orbital rake separator 902 helps gently feed the product from the hopper conveyor belt 900 into the size separation tool 904. In a third step, the size separation tool 904 catches smaller components of the product in its slits or pockets. In a fourth step, the size separation tool 904 drops the smaller components of the product into a separated product catch pan 906, where the smaller components of the product accumulate. In a fifth step, larger components of the product are moved forward on the diverter conveyor belt 908.

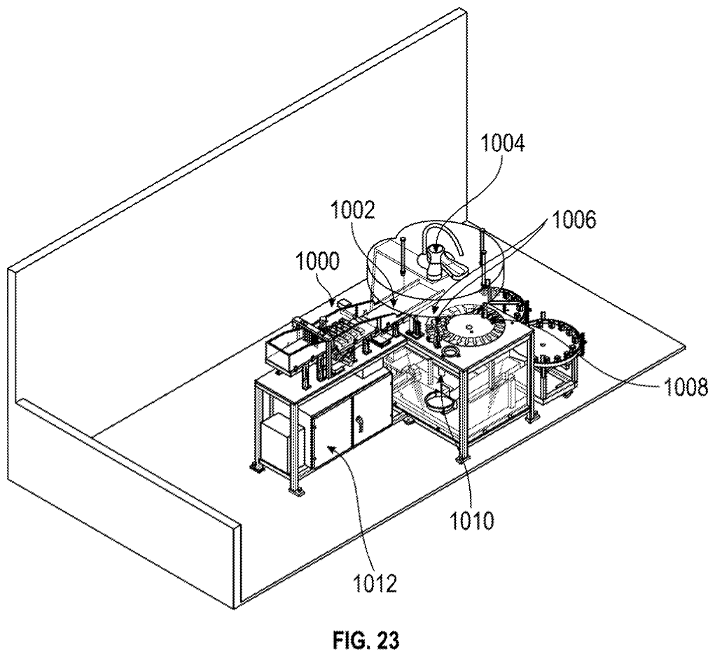

Turning now to FIG. 23, an embodiment of the Automated Sorting and Packaging System for a Farm with Robots Working on Plants is shown. A worker or another automated device places cannabis or hemp buds and/or flowers onto a flower separating system 1000, which may be similar to the Automated Feeding System for a Farm with Robots Working on Plants shown in FIGS. 19 through 22. The product is moved through the flower separating system 1000 to the pickup area 1002, where a vision guided robot 1004 takes pictures of all the cannabis or hemp buds and/or flowers in the pickup area 1002. The vision guided robot 1004 picks up cannabis or hemp buds and/or flowers and places them in one of the scales 1006.

By way of the scales 1006 and the pictures taken by the vision guided robot 1004, the size and the weight of each bud and/or flower is now known. The buds and/or flowers are then packaged or placed in temporary storage bins 1008. The scales 1006 and/or temporary storage bins 1008 are arranged and mechanized in cooperation with a container handling system, in order to allow the contents to be deposited in shipping containers 1010. Specifically, a motor driven gate arrangement may be connected to the scales 1006 and/or to the temporary storage bins 1008. In at least one embodiment of the Automated Sorting and Packaging System, a motor driven gate arrangement is connected to the scales 1006, and is configured so that when the motor rotates in one direction, a gate opens allowing the flower or bud to move into one of the temporary storage bins 1008. When the motor rotates in the other direction, another gate opens allowing the flower or bud to move into a shipping container 1010 by way of a tube. In another embodiment of the Automated Sorting and Packaging System, the vision guided robot 1004 is responsible not only for moving the flowers and/or buds from the pickup area 1002 to the scales 1006, but also for moving the flowers and/or buds between the scales 1006, the temporary storage bins 1008, and the shipping containers 1010.

A computer-based control system 1012 is used to control the Automated Sorting and Packaging System for a Farm with Robots Working on Plants, including the vision guided robot 1004, and to collect data. This unique computer-based control system 1012 is provided with one or more algorithms that utilize the size and weight data provided by the packaging process to determine an average container mix of various size buds and/or flowers. The computer-based control system 1012 may further be provided with one or more algorithms that allow the operator to determine the desired contents of an average container, so that the computer-based control system 1012 fills the shipping containers 1010 accordingly.

The computer-based control system 1012 associates the vision data size in pixels with the measured weight of each of the cannabis or hemp flowers and/or buds. As the Automated Sorting and Packaging System for a Farm with Robots Working on Plants operates, the association average continues to calculate, increasing the accuracy of the average. This data can then be recalled as a starting point for a new batch of cannabis or hemp flowers and/or buds. By using all stored locations and all “seen flowers and/or buds” on the pickup area 1002, a large number of flowers and/or buds are considered while the algorithm of the computer-based control system 1012 calculates how to fill each container to an accurate weight.

The Automated Feeding System for a Farm with Robots Working on Plants functions by: 1) weighing each cannabis or hemp flower and/or bud using the scales 1006, 2) storing each flower and/or bud in a storage container 1008, 3) moving the flowers and/or buds to temporary storage bins 1008 in combination until the correct mix of flower and/or bud sizes and weights are accomplished, and 4) moving each group of flowers and/or buds to containers. The Automated Feeding System for a Farm with Robots Working on Plants can also be configured with additional scales that have storage features and the ability to deliver product to specific packages. Moreover, the computer-based control system 1012 of the Automated Feeding System for a Farm with Robots Working on Plants may store and track data for each and every cannabis or hemp flower and/or bud for inventory and consumer information purposes.

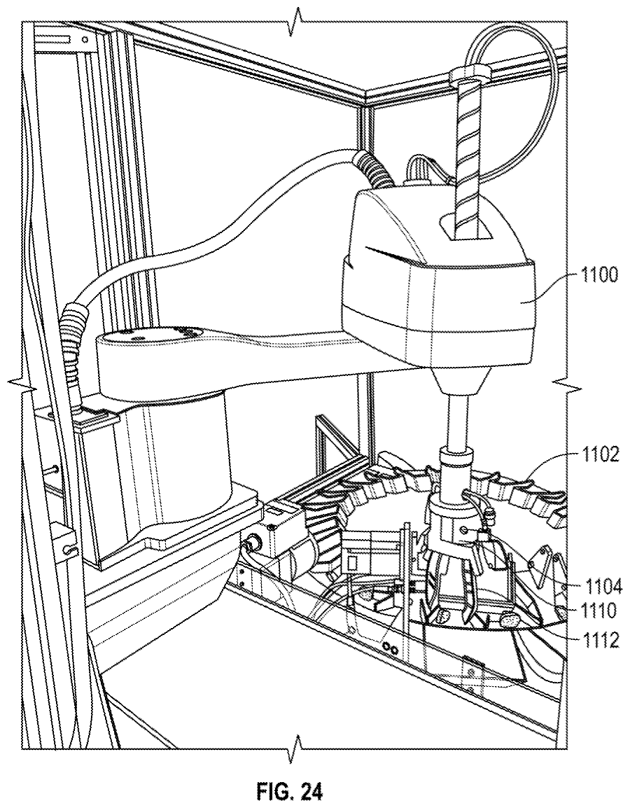

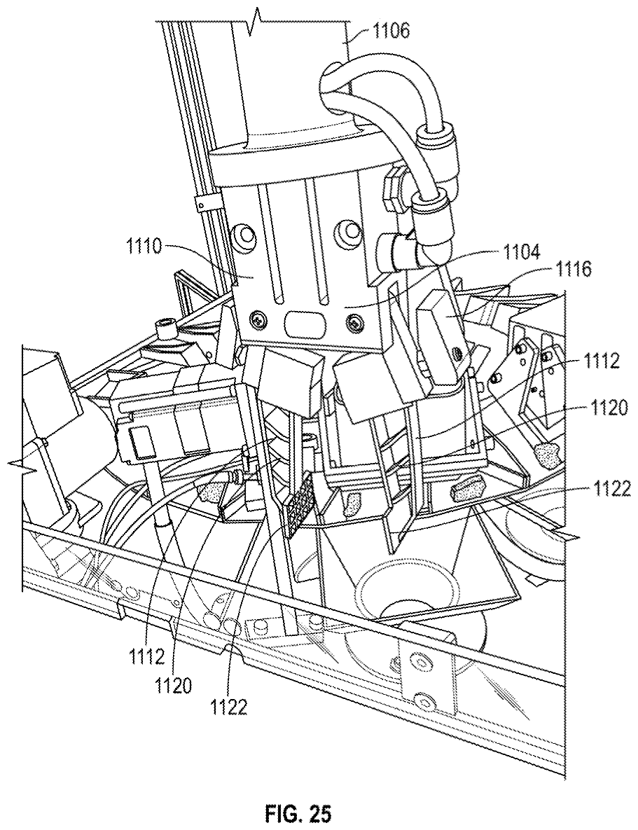

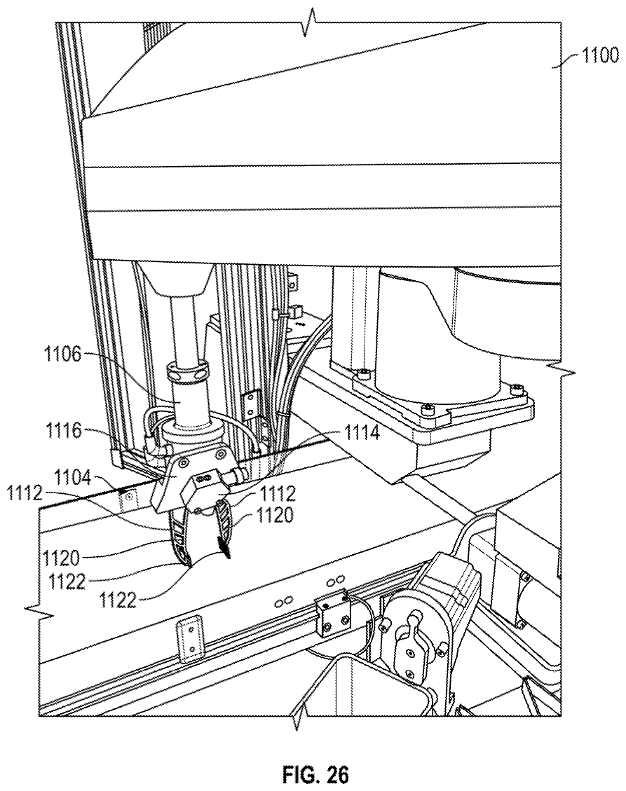

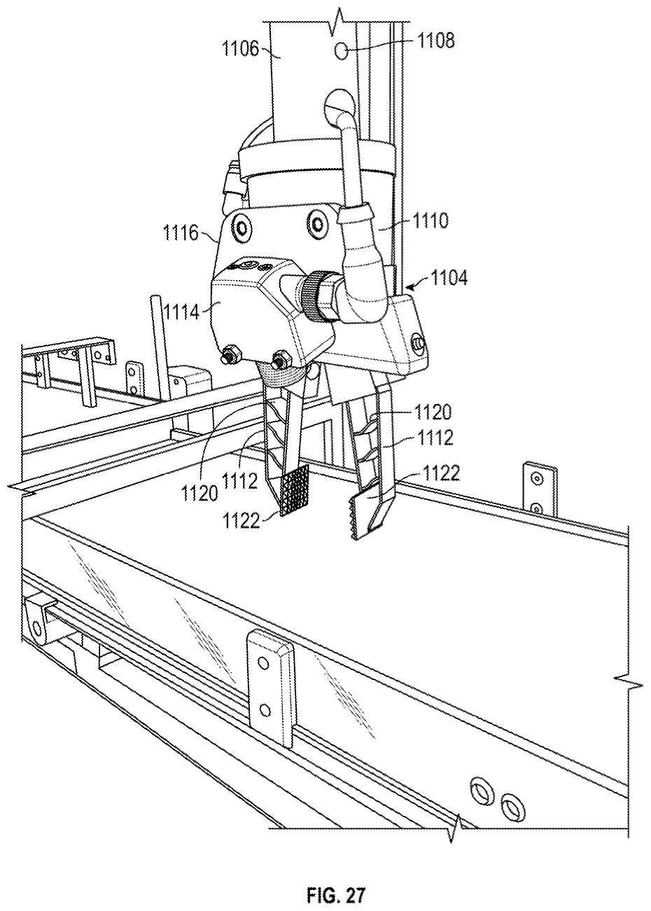

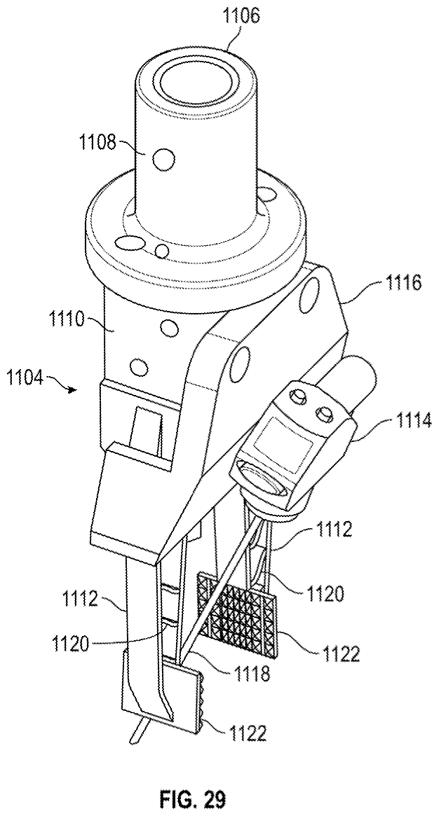

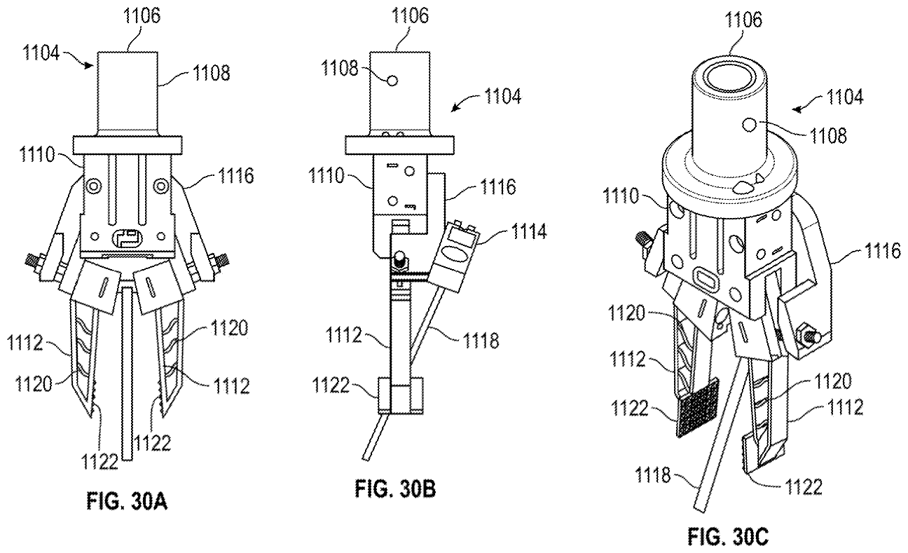

Turning now to FIGS. 24 through 30C, a vision guided robot 1100 is shown, which may be similar to the vision guided robot 1004 of the embodiment of the Automated Sorting and Packaging System for a Farm with Robots Working on Plants shown in FIG. 23. The vision guided robot 1100 is arranged to move cannabis or hemp flowers and/or buds to and between storage containers 1102. In order to do so, the vision guided robot 1100 is provided with a robotic gripper 1104. The robotic gripper 1104 is attached to the vision guided robot 1100 by way of a gripper flange mount 1106 retained using a set screw 1108. The robotic gripper 1104 is provided with a gripper body 1110 containing a known mechanism for moving gripper fingers 1112 between an open position and a closed or gripping position.

In the embodiment of the Automated Sorting and Packaging System for a Farm with Robots Working on Plants shown in FIG. 23, the gripper fingers 1112 are configured with a gripper finger truss 1120 that transfers the gripping force from the mechanism of the gripper body 1110 to interchangeable grip surfaces 1122. Moreover, the gripper fingers 1112 may be fashioned from a soft and pliable material, such as for non-limiting example thermoplastic polyurethane, and may be manufactured using a 3D printer, as noted previously. Further, select portions of the gripper finger truss 1120, such as the inner chords, the outer chords, the webs, and/or the nodal joints therebetween, or any combination thereof, may be fashioned from a soft and pliable material, while the remainder thereof may be fashioned from stiffer material. In this way, the gripping force transmitted from the mechanism of the gripper body 1110 to the interchangeable grip surfaces 1122 may be finely tuned to the needs of handling cannabis or hemp flowers and/or buds.

It is again noted that the interchangeable grip surfaces 1122 may be wider than the gripper finger truss 1120, in order to facilitate picking up more than one flower and/or bud, and to further reduce the gripping pressure. Further, it is noted that, if the flowers and/or buds are sticky, grip surfaces that are smooth may work best, whereas, if the flowers and/or buds are hard and dry, a grip surface with a tread may work best to prevent the flowers and/or buds from falling from the gripper fingers 1112 during rapid movements of the vision guided robot 1100.

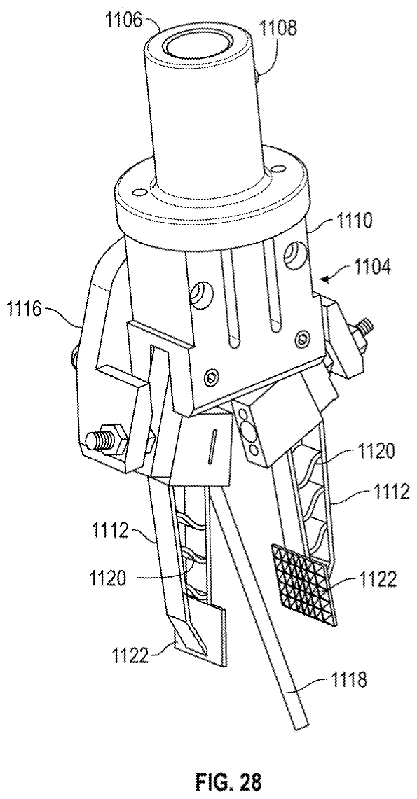

The robotic gripper 1104 of the vision guided robot 1100 may further be provided with a gripper sensor 1114 attached to the gripper body 1110 by way of a sensor bracket 1116. The gripper sensor 1114 may, for non-limiting example, be a laser proximity sensor. Alternately, the gripper sensor 1114 may be a camera or other visual sensor. Still alternately, the gripper sensor 1114 may be any type of sensor capable of resolving object size and position. The vision guided robot 1100 uses the gripper sensor 1114 to confirm that a flower or bud is successfully picked up. Further, the vision guided robot 1100 may use the gripper sensor 114 to locate and provide vision data concerning the cannabis or hemp flowers and/or buds, where the gripper sensor 1114 is embodied as a camera or other visual sensor. The focus area of the gripper sensor 1114 is represented by a sensor beam 1118 in FIGS. 28 through 30C.

While the Automated Feeding, Sorting, and Packaging System for a Farm with Robots Working on Plants has been described with respect to at least one embodiment, the Automated Feeding, Sorting, and Packaging System for a Farm with Robots Working on Plants can be further modified within the spirit and scope of this disclosure, as demonstrated previously. This application is therefore intended to cover any variations, uses, or adaptations of the Automated Feeding, Sorting, and Packaging System for a Farm with Robots Working on Plants using its general principles. Further, this application is intended to cover such departures from the present disclosure as come within known or customary practice in the art to which the disclosure pertains and which fall within the limits of the appended claims.

REFERENCE NUMBER LISTING

| | |
|---|---|
| 10 | Building with single slope roof |
| 12 | Exhaust stack |
| 14 | Exhaust blower |
| 16 | Activated Charcoal filter |
| 18 | Ozone generators |
| 20 | Attic circulation fans |
| 22 | Grow room exhaust fan |
| 24 | CO2 nozzle |
| 26 | Spray nozzle |
| 28 | Grow lights |
| 30 | Automated light rack |
| 32 | Automated light rack posts |
| 34 | Integrated screw jack |
| 36 | Split HVAC system |
| 38 | Sensors |
| 40 | Ceiling fan |
| 42 | Humidifier/dehumidifier |
| 44 | Room air filter |
| 46 | Grow room/Flower room with lights |
| 48 | Grow room/Flower room without lights |
| 50 | Preconditioned air hallway |
| 100 | Equipment and tank room |
| 102 | Clone and parent room |
| 104 | Harvest room |
| 106 | Trim and pruning room |
| 108 | Laboratory |
| 110 | Vegetation grow room |
| 112 | Flower room with lights |
| 114 | Flower room without lights |
| 116 | Air intakes |
| 150 | Parent power roller conveyor |
| 152 | Chain transfer |
| 154 | Gravity skate wheel conveyor |
| 156 | Pallet stops |
| 158 | Lift mechanism |
| 160 | Parent plant pot |
| 200 | Child conveyor tray |
| 202 | Child storage racks |
| 204 | Gravity conveyor |
| 206 | Lifting mechanism |
| 208 | Track |
| 210 | Storage and retrieval system |
| 212 | Movable shelf |
| 214 | Powered wheels |
| 250 | Grow room |
| 252 | Conveyor plant testing and watering section |
| 254 | Automated testing station |
| 256 | Conveyors |
| 258 | Hallway |
| 260 | Cross transfer |
| 262 | Conveyor frame |
| 264 | Offset splice tubes |
| 266 | Bolt-on spacer bar |
| 268 | Splice-on gusset and fish plate |
| 270 | Roller bracket |
| 272 | Two groove rollers |
| 274 | Drive belt |
| 276 | Drive rollers |
| 278 | Bearings with two hole strap |
| 280 | Set screws |
| 282 | Tapped holes |
| 300 | Tray and trellis system |
| 302 | Tray |
| 304 | Rotation holder |
| 306 | Trellis frame |
| 308 | Trellis combs |
| 310 | Trellis comb spine |
| 312 | Trellis comb ribs |
| 350 | Backlight tablet tool |
| 352 | Grip-cut tool |
| 354 | Cannabis or hemp plant |
| 356 | Room |
| 358 | Backlight tablet tool holding robot |
| 360 | Grip-cut tool holding robot |
| 362 | Trim recovery system |
| 364 | Catch tray |
| 366 | Catch tray actuator |
| 400 | Parent plant pot |
| 402 | Training system |
| 404 | Corner posts |
| 406 | Training arms |
| 408 | Adjustable clamp |
| 450 | Parent plant conveyor |
| 452 | Backlight tablet tool holding robot |
| 454 | Grip-cut tool holding robot |
| 456 | Roller conveyor turn table |
| 458 | Cannabis or hemp plant |
| 460 | Clone planting pedestal |
| 462 | Rockwool plug robot |
| 464 | pH controlled rinse tanks |
| 466 | Flex feeder |
| 468 | Tote dumper |
| 470 | Child tray |
| 472 | Child conveyor |
| 474 | Temperature and humidity controls |
| 476 | First nursery chamber |
| 478 | Second nursery chamber |
| 480 | Plant racks |
| 482 | Transporter rack |
| 484 | Transporter |
| 486 | Transplant robot |
| 488 | Conveyor |
| 490 | Gantry frame |
| 492 | Top layer pusher and scissor lift |
| 494 | Gantry head with integrated shelf |
| 496 | Preparation tanks |
| 498 | Dunnage |
| 500 | Conveyor |
| 502 | Clone preparation tank |
| 504 | Rooting hormone solution |
| 506 | Fixed blade |
| 508 | Movable blade |
| 510 | Actuator |
| 550 | Portable spray station |
| 552 | Frame |
| 554 | Wheels |
| 556 | Handle |
| 558 | Fluid tank and pump system |
| 560 | Air hose and control power cord |
| 562 | Control system |
| 564 | Spray nozzles |
| 566 | Compressor tank |
| 600 | Automated harvesting cell |
| 602 | Conveyor turntable |
| 604 | Standard conveyor section |
| 606 | Backlight tablet tool holding robot |
| 608 | Grip-cut tool holding robot |
| 610 | Trimming or pruning robot system |
| 612 | Conveyor |
| 614 | Rockwool bailer |
| 616 | Tray wash and dry system |
| 650 | Curing cabinet |
| 652 | Drawers |
| 654 | Air exchange system |
| 656 | Intake filter |
| 658 | Charcoal exhaust filter |
| 660 | Control system |
| 700 | Control system network |
| 702 | Modem |
| 704 | Farm server |
| 706 | Office PCs |
| 708 | Farm manager |
| 710 | Tech support |
| 712 | Master gardener |
| 714 | Sales |
| 716 | Ethernet |
| 718 | Cloning cell |
| 720 | Programmable logic controller |
| 722 | Human machine interface |
| 724 | Robot vision controller |
| 726 | Main programmable logic controller |
| 728 | Room controller |
| 730 | Programmable logic controller I/O |
| 732 | Human machine interface |
| 734 | Vision system |
| 736 | Hallway conveyor control |
| 738 | Programmable logic controller I/O |
| 740 | Human machine interface |
| 750 | Cannabis or hemp plant |
| 752 | Parent plant pot |
| 754 | Parent plant pot turntable |
| 756 | Pot rotating motor |
| 758 | Backlight tablet tool holding robot |
| 760 | Backlight tablet tool holding robot pedestal |
| 762 | Grip-cut tool holding robot |
| 764 | Grip-cut tool holding robot pedestal |
| 766 | Plant manipulator |
| 768 | Manipulator attachment |
| 800 | Backlight assembly |
| 802 | Backlight enclosure plate |
| 804 | Backlight backing plate |
| 806 | Backlight cover plate |
| 808 | Backlight edging |
| 810 | Backlight robot adapter extension |
| 812 | Backlight robot adapter |
| 814 | Torx flat head screw |
| 816 | Socket head cap screw |
| 818 | Backlight adapter |
| 820 | Backlight screen |
| 850 | Backlight tablet tool holding robot |
| 852 | Backlight tablet tool holding robot pedestal |
| 854 | Backlight assembly |
| 860 | Grip-cut tool |
| 862 | Plant sensor |
| 864 | Grip-cutter |
| 866 | Grip-cutter actuator |
| 868 | Cannabis or hemp plant |
| 880 | Grip-cut tool holding robot |
| 882 | Grip-cut tool holding robot pedestal |
| 884 | Grip-cut tool |
| 900 | Hopper conveyor belt |
| 902 | Orbital rake separator |
| 904 | Size separation tool |
| 906 | Separated product catch pan |
| 908 | Diverter conveyor belt |
| 910 | Static diverter posts |
| 912 | Pickup conveyor belt |
| 914 | Backlight/pickup location |
| 916 | Separated product catch pan |
| 918 | Separated product catch pan |
| 920 | Backlight service door |
| 1000 | Flower separating system |
| 1002 | Pickup area |
| 1004 | Vision guided robot |
| 1006 | scales |
| 1008 | Temporary storage bins |
| 1010 | Shipping container |
| 1012 | Computer-based control system |
| 1100 | Vision guided robot |
| 1102 | Storage containers |
| 1104 | Robotic gripper |
| 1106 | Gripper flange mount |
| 1108 | Set screw |
| 1110 | Gripper body |
| 1112 | Gripper fingers |
| 1114 | Gripper sensor |
| 1116 | Sensor bracket |
| 1118 | Sensor beam |
| 1120 | Gripper finger truss |
| 1122 | Interchangeable grip surface |

What is claimed is:

1. An automated farm having an automated feeding, sorting, and packaging system, comprising:
a first conveyor belt;
a second conveyor belt adjacent to the first conveyor belt configured to move slightly faster than the first conveyor belt;
a rotating size separation tool having slits or pockets, located between the first and second conveyor belt;
a pickup conveyor belt;
a vision sensor;
a vision guided robot adjacent to the pickup conveyor belt, the vision guided robot being provided with a robotic gripper;
at least one scales adjacent to the vision guided robot;
an arrangement of temporary storage bins adjacent to the vision guided robot;
a container handling system; and
a computer-based control system connected to the vision guided robot and to the at least one scales.

2. The automated farm of claim 1, further comprising:
at least one of:
at least one orbital rake separator mounted above one of the conveyor belts,
at least one static diverter post mounted above one of the conveyor belts, and
at least one belt scraping mechanism in contact with one of the conveyor belts.

3. The automated farm of claim 1, wherein:
the pickup conveyor belt is back lit.

4. The automated farm of claim 1, wherein:
the rotating size separation tool one of:
rotates in the same direction as the first and second conveyor belts,
rotates in the opposite direction as the first and second conveyor belts, and
alternates between rotating in the same direction and in the opposite direction as the first and second conveyor belts.

5. The automated farm of claim 4, further comprising:
an air ionizer located proximate to the rotating size separation tool.

6. The automated farm of claim 1, wherein:
the computer-based control system being configured with at least one algorithm that utilizes weight data provided by the at least one scales and size data provided by the vision sensor to determine and/or prepare an average container mix of various size and weight products.

7. The automated farm of claim 6, wherein:
the at least one algorithm further being configured to increase the accuracy of the average container mix by accumulating size data and weight data over a batch of product.

8. The automated farm of claim 6, wherein:
the at least one algorithm further being configured to store and track data for each item of product in each container mix for inventory and consumer information purposes

9. The automated farm of claim 1, wherein:
the vision sensor is one of:
attached to the robotic gripper, and
located above the pickup conveyor belt.

10. The automated farm of claim 1, wherein:
the robotic gripper being provided with at least one gripper finger having at least one gripper finger truss that transfers gripping force from the robotic gripper to at least one grip surface.

11. The automated farm of claim 10, wherein:
at least a portion of the at least one gripper finger truss being made from a soft and pliable material.

12. The automated farm of claim 11, wherein:
the portion of the at least one gripper finger truss being made from a soft and pliable material, being further made from thermoplastic polyurethane.

13. The automated farm of claim 12, wherein:
the at least one gripper finger truss being manufactured using a 3D printer.

14. The automated farm of claim 10, wherein:
the at least one grip surface being interchangeable, and being wider than the at least one gripper finger truss.

15. An automated feeding, sorting, and packaging system, comprising:
a first conveyor belt;
a second conveyor belt adjacent to the first conveyor belt configured to move slightly faster than the first conveyor belt;
a rotating size separation tool having slits or pockets, located between the first and second conveyor belt;
a pickup conveyor belt;
a vision sensor;
a vision guided robot adjacent to the pickup conveyor belt, the vision guided robot being provided with a robotic gripper;
at least one scales adjacent to the vision guided robot;
an arrangement of temporary storage bins adjacent to the vision guided robot;
a container handling system; and
a computer-based control system connected to the vision guided robot and to the at least one scales.

16. The automated feeding, sorting, and packaging system of claim 15, further comprising:
at least one of:
at least one orbital rake separator mounted above one of the conveyor belts,
at least one static diverter post mounted above one of the conveyor belts, and
at least one belt scraping mechanism in contact with one of the conveyor belts.

17. The automated feeding, sorting, and packaging system of claim 15, wherein:
the pickup conveyor belt is back lit.

18. The automated feeding, sorting, and packaging system of claim 15, wherein:
the rotating size separation tool one of:
rotates in the same direction as the first and second conveyor belts,
rotates in the opposite direction as the first and second conveyor belts, and
alternates between rotating in the same direction and in the opposite direction as the first and second conveyor belts.

19. The automated feeding, sorting, and packaging system of claim 18, further comprising:
an air ionizer located proximate to the rotating size separation tool.

20. The automated feeding, sorting, and packaging system of claim 15, wherein:
the computer-based control system being configured with at least one algorithm that utilizes weight data provided by the at least one scales and size data provided by the vision sensor to determine and/or prepare an average container mix of various size and weight products.

21. The automated feeding, sorting, and packaging system of claim 20, wherein:
the at least one algorithm further being configured to increase the accuracy of the average container mix by accumulating size data and weight data over a batch of product.

22. The automated feeding, sorting, and packaging system of claim 20, wherein:
the at least one algorithm further being configured to store and track data for each item of product in each container mix for inventory and consumer information purposes.

23. The automated feeding, sorting, and packaging system of claim 15, wherein:
the vision sensor is one of:
attached to the robotic gripper, and
located above the pickup conveyor belt.

24. The automated feeding, sorting, and packaging system of claim 15, wherein:
the robotic gripper being provided with at least one gripper finger having at least one gripper finger truss that transfers gripping force from the robotic gripper to at least one grip surface.

25. The automated feeding, sorting, and packaging system of claim 23, wherein:
at least a portion of the at least one gripper finger truss being made from a soft and pliable material.

26. The automated feeding, sorting, and packaging system of claim 25, wherein:
the portion of the at least one gripper finger truss being made from a soft and pliable material, being further made from thermoplastic polyurethane.

27. The automated feeding, sorting, and packaging system of claim 26, wherein:
the at least one gripper finger truss being manufactured using a 3D printer.

28. The automated feeding, sorting, and packaging system of claim 24, wherein:
the at least one grip surface being interchangeable, and being wider than the at least one gripper finger truss.

29. A method for automated farming, comprising the steps of:
providing a first conveyor belt;
configuring a second conveyor belt adjacent to the first conveyor belt to move slightly faster than the first conveyor belt;
arranging a rotating size separation tool having slits or pockets, between the first and second conveyor belt;
providing a pickup conveyor belt;
providing a vision sensor;
arranging a vision guided robot adjacent to the pickup conveyor belt;
providing the vision guided robot with a robotic gripper;
providing at least one scales adjacent to the vision guided robot;
providing an arrangement of temporary storage bins adjacent to the vision guided robot;
providing a container handling system; and
connecting a computer-based control system to the vision guided robot and to the at least one scales.

30. The method of claim 29, further comprising the steps of:
configuring the computer-based control system with at least one algorithm that utilizes weight data provided by the at least one scales and size data provided by the vision sensor to determine and/or prepare an average container mix of various size and weight products.

31. The method of claim 30, further comprising the steps of:
further configuring the at least one algorithm to increase the accuracy of the average container mix by accumulating size data and weight data over a batch of product.

32. The method of claim 30, further comprising the steps of:
further configuring the at least one algorithm to:
allow a user to defines an ideal package size, weight, number of flowers and/or buds, and acceptable size range for flowers and/or buds;
measure the weight range of each flower and/or bud using the at least one scales;
measure the size range of each flower and/or bud using a vision sensor attached to the vision guided robot;
classify the flowers and/or buds into defined ranges;
store the flowers and/or buds that fit within the acceptable size range in temporary storage bins;
create combinations of flowers and/or buds that match the determined average container mix of flower and/or bud sizes and weights; and
move each combination of flowers and/or buds to containers.

33. The method of claim 32, further comprising the steps of:
further configuring the at least one algorithm to:
check all possible combinations for a given number of flowers and/or buds;
retain each combination in memory having at least one flower and/or bud from each range; and
process the combination closest to the target weight, but not less than the target weight, and within tolerance.

34. The method of claim 29, further comprising the steps of:
providing the robotic gripper with at least one gripper finger having at least one gripper finger truss that transfers gripping force from the robotic gripper to at least one grip surface, at least a portion of the at least one gripper finger truss being made from a soft and pliable material.
